(19) United States
(12) Patent Application Publication
(10) Pub. No.: US 2015/0033982 A1
(43) Pub. Date: Feb. 5, 2015

(54) MIXING DEVICE, MIXING BLADES AND METHOD FOR MIXING CALCIUM ALUMINATE-CONTAINING SLURRIES

(71) Applicant: General Electric Company, Schenectady, NY (US)

(72) Inventors: Bernard Patrick BEWLAY, Niskayuna, NY (US); Stephen Francis BANCHERI, Albany, NY (US); Joan MCKIEVER, Ballston Lake, NY (US); Brian Michael ELLIS, Mayfield, NY (US); Nicholas Vincent MCLASKY, Niskayuna, NY (US)

(73) Assignee: General Electric Company, Schenectady, NY (US)

(21) Appl. No.: 14/199,300

(22) Filed: Mar. 6, 2014

Related U.S. Application Data
(60) Provisional application No. 61/861,681, filed on Aug. 2, 2013.

(51) Int. Cl. B01F 7/00; B22C 1/00; C04B 7/32

(52) U.S. Cl. CPC B01F 7/0015; B01F 7/00016; C04B 7/32; B22C 1/00
USPC 106/38.3; 366/65; 366/343

(57) ABSTRACT

A mixing device having a mixing container and has a single-shaft agitator that extends into the mixing container. At the end of the drive shaft, a rotor body is arranged slightly above the bottom of the mixing container. The rotor body comprises a plurality of mixing blades, wherein the blades are, in one example, star-shaped and fixed in position to each other. A first end of the drive shaft is coupled to a motor and a second end of the drive shaft is configured to extend into the mixing vessel, wherein the blades are attached onto the second end of the drive shaft. The blades in one example include at least two coincidental knife-edged blades such that at least one of the knife-edged blades is facing upward. The mixing device in one example is used to mix calcium aluminate-containing slurries.

### CROSS-REFERENCE TO RELATED APPLICATION

This application claims the benefit of provisional patent application U.S. Ser. No. 61/861,681, filed Aug. 2, 2013.

### BACKGROUND

The movement of a fluid through a container is characterized by its viscosity, which can be thought of as a sort of “internal friction” or resistance of the fluid to a change in form. The higher the viscosity, the slower the movement of the fluid. Viscosity tends to decrease as the temperature of the fluid increases, so fluid tends to flow faster at higher temperatures.

A fluid can typically be classified as one of two general types: a Newtonian fluid is one whose resistance to the passage of a moving object is wholly due to viscous effects, that is, strictly proportional to the speed of the object. Water and most oils are Newtonian fluids. A non-Newtonian fluid is one whose resistance to the passage of a moving object is not strictly proportional to its speed. Typically, such a fluid has “gel-like” properties, behaving as a solid at low levels of shear stress and a liquid at higher levels of shear stress. Common examples are jelly and wet cement.

Gel strength, customarily measured in pounds per square foot (p.s.f). or kilograms per square meter (kg/m²), is the force required to move a blade or other object through the setting mix at some specified uniform speed, over and above the force which would be required to move it through a non-setting, or Newtonian mix of equal viscosity. Usually a rotating assembly of two or more blades is used, and the gel strength is then given by the ratio of shaft torque, corrected for viscosity, to the rotational moment of the blade assembly.

Under uniform conditions of temperature and pressure, the gel strength typically increases with time, following an “S”-shaped curve. A period of little change just after mixing is followed by a roughly exponential increase to some peak or plateau value at which the gel strength levels off again. The timing of this process is highly dependent on batch composition, with even trace impurities sometimes showing a strong influence. Process optimization may thus require close monitoring of the time needed for each new batch to reach some specified gel strength or strengths.

A complication in gel-strength measurement is that mechanical disturbance tends to upset the gelling process; this is why wet cement can be carried for hours in mixing trucks without setting. Blade motion, therefore, must be as slow as possible for accurate gel-strength measurement. Low blade speeds also minimize the effects of viscosity, so that in general the measured gel strength can be used without correction.

Another complication is the tendency of a rotating blade assembly to “cut out a plug” from a setting mixture at some intermediate value of gel strength. A shear zone develops around the blade assembly, so that a cylindrical “plug” of mix, of the same outer radius as the blades, breaks away from the outer mass of mix. While setting continues in the plug and in the outer mass, the slippage disrupts gelling in the shear zone.

Thus, there is a need in the art for improved apparatus and blade systems that can be used to effectively mix viscous slurries, such that for example they can be used in the mixing of components in slurries that are used in the making of casting molds in the process of making gas turbine engine blades.

### SUMMARY

One object of the present disclosure is to provide improvements to a blade of a gas turbine engine.

The present disclosure is directed to a mixing device and a mixing method for at least two-stage mixing of a ceramic mix that is used for making molds for casting such as for titanium and titanium aluminide alloys.

In one aspect, the present disclosure is a mixing device for mixing a calcium aluminate-containing slurry, comprising a mixing vessel having an interior bottom surface and interior walls, wherein the mixing vessel is configured to contain the slurry; a motor-controlled drive shaft, wherein a first end of said drive shaft is coupled to a motor and a second end of the drive shaft is configured to extend into said mixing vessel; and a blade system attached onto said second end of the drive shaft, wherein the blade system includes at least two coincidental knife-edged blades such that at least one of the knife-edged blades is facing upward, wherein the knife-edged blades can be move up or down in the mixing vessel, and wherein the rotational speed of the knife-edged blades can be adjusted to be between 500 rpm to 5000 rpm. In one embodiment, the lowest blade of the blade system is less than about 50 mm from the interior bottom surface of the mixing vessel. In one embodiment, the blade system includes a third knife-edged blade perpendicular to said two coincidental knife-edged blades. In another embodiment, the drive shaft is coated and is substantially inside of the mixing vessel. In one embodiment, the blade system is coated.

In one embodiment, the blades are made of stainless steel or titanium coated stainless steel. In one embodiment, the blades are made of stainless steel and/or are coated with chromium or chromium-containing alloy. In another embodiment, the angle of the drive shaft with respect to the mixing vessel is about 90 degrees; that is the drive shaft is substantially vertical compared to the bottom of the mixing vessel.

In one embodiment, the blade system is about 10 mm from the bottom of the mixing vessel. In another embodiment, during operation of the motor, the rotation speed of the blades is from about 1500 rpm to about 3500 rpm. In one embodiment, the blade system is from about 30 mm to about 50 mm from the bottom of the mixing vessel. In one embodiment, the blade system is from about 6 cm to about 12 cm from the bottom of the mixing vessel. In one embodiment, before the second mixture of large scale hollow particles is mixed in, the blade system is lifted to about 11 cm from the bottom of the mixing vessel. During operation of the motor, in one embodiment, the rotation speed of the blades is from about 500 rpm to about 1500 rpm.

In one aspect, the present disclosure is directed to a mixing method, for example, a method for mixing a calcium aluminate and oxide particle-containing slurry, comprising: adding a first mixture comprising calcium aluminate into a mixing vessel; deploying a motor-controlled drive shaft, comprising a first end that is coupled to a motor and a second end that is coupled to a blade system, said drive shaft inserted into said mixing vessel such that the blade system is about 10 mm from an interior bottom of the mixing vessel, and wherein the blade system has at least two blades coincident with each other; turning the motor on and adjusting a speed of the blade system such that a rotation speed of the blades is from about 1500 rpm to about 3500 rpm; mixing said first mixture until sufficiently mixed; adjusting a position of the blade system such that it is from about 30 mm to about 50 mm from the interior bottom of the mixing vessel, and adjusting rotation speed of the blade system such that the rotation speed of the blades is from about 500 rpm to about 1500 rpm; adding a second mixture comprising oxide particles into the mixing vessel; and mixing the first mixture and the second mixture inside the same mixing vessel, wherein the blade system rotates and mixes in radial and rotational directions.

In one embodiment, the present disclosure is directed to method for mixing a calcium aluminate slurry, comprising placing a first mixture comprising calcium aluminate into a mixing vessel; and deploying a drive shaft comprising a motor and a blade system into said mixing vessel, wherein the blade system has at least two blades coincident with each other, and wherein when the blades are in contact with the first mixture and the motor is turned on, the blade system rotates and the calcium aluminate slurry is mixed in the radial and rotational directions. In one embodiment, the first mixture comprises calcium aluminate. In another embodiment, before deploying a drive shaft, a second mixture is added into the mixing vessel. The motor, in one embodiment, is operably attached to the drive shaft. In one embodiment, when the motor is on, the blade system revolutions per minute can be controlled via a dial.

In one embodiment, said second mixture comprises hollow large scale oxide particles. The hollow oxide particles may comprise hollow alumina spheres. In one embodiment, before deploying a drive shaft, a second mixture is added into the mixing vessel comprising aluminum oxide particles, magnesium oxide particles, calcium oxide particles, zirconium oxide particles, titanium oxide particles, or combinations thereof. In one embodiment, before deploying a drive shaft, a second mixture is added into the mixing vessel comprising a ceramic, such as calcium aluminate, calcium hexaluminate, zirconia, or combinations thereof.

In one embodiment, when operational, the blade system provides shear force to a viscosity of about 20 centipoises to about 150 centipoises. In another embodiment, the blade system has at least two blades coincident with each other and when the motor is on and the blades are turning, the first mixture is mixed in the radial and rotational directions. In one embodiment, the calcium aluminate is in the form of fine scale calcium aluminate and wherein a second mixture comprising large hollow particles are added to the calcium aluminate. In one embodiment, the calcium aluminate particles comprise particles of calcium monoaluminate, calcium dialuminate, and mayenite.

In another embodiment, the first mixture comprises calcium aluminate particles of less than about 50 microns in outside dimension. In one embodiment, the method further comprises adding a second mixture to the calcium aluminate. In another embodiment, the first mixture comprises particles of calcium aluminate that are less than about 50 microns in outside dimension and the second mixture comprises oxide particles that are substantially hollow particles of about 100 microns to 1000 microns in outside dimension.

In one embodiment, the blade system is used in the presently disclosed method. In one embodiment, the blade system comprises at least two knife-edged blades positioned coincident to each other in the radial and rotational directions, wherein the knife-edged blades are different in size, at least one of the knife-edged blades is facing upward. In one embodiment, the drive shaft is placed substantially inside the mixing vessel, and the blades attached to the drive shaft are close to the interior bottom surface of the mixing vessel. In one embodiment, the mixing vessel further comprises a powder feed funnel for adding the first and second mixtures into the mixing vessel, wherein said funnel has one side that is flat such that when the funnel is in contact with the mixing vessel, said flat side stays flush with the mixing vessel. In another embodiment, the funnel has an opening of about 20 cm to about 40 cm, and wherein the funnel has a spout with an opening of about 7 cm through which the first mixture is added to the mixing vessel. In one embodiment, during operation of the motor, the spinning blade system generates a toroid in the slurry.

One aspect of the present disclosure is directed to a blade system, comprising at least two knife-edged blades positioned coincident to each other in the radial and rotational directions, wherein the knife-edged blades are different in size, at least one of the knife-edged blades is facing upward, and further wherein the blade system is attached to the rotatable shaft, and wherein the knife-edged blades are used for mixing a calcium aluminate-containing slurry. In one example, a nut tack may be welded on top of at least one of the knife-edged blades. In one embodiment, the blade system further comprises a third knife-edged blade that is perpendicular to said two coincidental knife-edged blade. In one embodiment, the knife-edged blades operate in the radial, r, rotational, theta, and axial, z, directions. In one embodiment, the blade system is coated. In one embodiment, the blades are made of stainless steel and/or are coated with titanium or a titanium-containing alloy. In one embodiment, the knife-edged blades are star-shaped; for example, the knife-edged blades are arranged in the configuration of a star polygon. In another embodiment, each blade of the blade system has a top surface and a bottom surface and two vanes. In one embodiment, the blade system is attached to a shaft that extends into the mixing vessel from the top of the mixing vessel. In another embodiment, the shaft with the blade system extends into the mixing vessel from the bottom of the mixing vessel. The blade system and/or the shaft may be coated. In one embodiment, the knife-edged blades operate in at least two of radial, rotational, and axial directions.

These and other aspects, features, and advantages of this disclosure will become apparent from the following detailed description of the various aspects of the disclosure taken in conjunction with the accompanying drawings.

### BRIEF DESCRIPTION OF THE FIGURES

The foregoing and other features and advantages of the disclosure will be readily understood from the following detailed description of aspects of the present disclosure taken in conjunction with the accompanying drawings in which:

FIG. 1A-E show diagrams showing the geometry of the typical blades used in the mixer of the present system. On the left hand side (FIG. 1A) an angled blade is shown, and on the right hand side (FIG. 1C) a straight blade is shown. FIG. 1B and 1D show projection side of the angled blade and straight blade, respectively. A schematic profile of the blade is shown in FIG. 1E, where the thickness of the blade and the geometry of the knife edge are shown.

FIG. 2 shows a perspective side view of the blade assembly consisting of two angled blades and one straight blade.

FIG. 3 shows a top perspective view of the blade assembly including the profile of the knife edge; this blade profile is effective in dispersing the agglomerates in the calcium aluminate cement.

FIG. 4 shows a bottom perspective view of the blade assembly.

FIG. 5 shows further perspective views of the blade assembly.

FIG. 6A shows side perspective views of the blade assembly mounted on the mixing shaft prior to insertion in the mixing vessel. This further shows three blades of the blade assembly.

FIG. 6B shows another side perspective view of the blade assembly from a closer range.

FIG. 7 shows the blade assembly mounted on the mixing shaft prior to insertion in the mixing vessel with a Teflon coating on the mixing shaft. The coating helps to prevent build up of slurry on the mixing shaft.

FIG. 8 shows the blade assembly mounted on the mixing shaft and inserted in the stainless steel mixing vessel.

FIG. 9 shows the blade assembly mounted on the mixing shaft and inserted in the stainless steel mixing vessel, wherein the mixer is being used to mix the water and colloidal silica.

FIG. 10A shows the blade assembly mounted on the mixing shaft and mixing the water and colloidal silica as well as depicting a funnel that is used to feed calcium aluminate cement into the mix.

FIG. 10B shows the blade assembly mounted on the mixing shaft and mixing the slurry that consisted of calcium aluminate cement, water, and colloidal silica.

FIG. 11A-11C shows the funnel feed as it relates in position to the mixing assembly, wherein the funnel feed is used to introduce components into the mixing vessel.

FIG. 12A shows the geometry of a Cowles blade, and FIG. 12B shows a Cowles blade attached to the drive shaft.

FIG. 13A shows a Cowles blade attached to a drive shaft that is inserted into a mixing vessel. FIG. 13B shows FIG. 13A after a mixture of calcium aluminate and water has been added and the Cowles blade made operational. The shaft in this example is shown offset from the symmetry axis of the mixing vessel.

FIG. 14A shows the inside of a blender mixing vessel, showing the blender with the open knife blade system attached to a drive shaft and introduced into the mixing vessel from the bottom of the mixing vessel.

FIG. 14B shows the inside of a blender mixing vessel, showing the Cowles blade attached to a drive shaft and introduced into the mixing vessel from the bottom of the mixing vessel.

FIG. 14C shows the entire blender mixing vessel.

FIG. 15A shows shrouded top motor and the shaft in-line high shear mixer.

FIG. 15B shows the rotor-stator attachment sitting in the bottom of the mixing vessel.

FIG. 15C shows the rotor-stator attachment after the aborted mix due to motor overload.

FIG. 16A shows a close up view from the side of the shrouded in-line high shear mixer attachment.

FIG. 16B shows a close up view of the bottom of the shrouded in-line high shear mixer attachment.

FIG. 17 shows the slurry mixture that forms using the shrouded rotor-stator blade with the top motor and shaft set up. As depicted, many air bubbles are formed in the slurry.

FIG. 18 shows a table reciting the steps of a method for mixing a calcium aluminate and oxide particle-containing slurry.

### DETAILED DESCRIPTION

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

The present disclosure is directed to a mixing device and a mixing method for at least a two-stage mixing of a ceramic mix that is used for making molds for casting titanium and titanium aluminide alloys.

In one aspect, the present disclosure is a mixing device for mixing a calcium aluminate-containing slurry. The mixing device comprises a mixing vessel; a motor-controlled drive shaft, wherein a first end of the drive shaft is coupled to a motor and a second end of the drive shaft is configured to extend into the mixing vessel. The device also comprises a blade system attached onto the second end of the drive shaft. The blade system includes at least two coincidental knife-edged blades such that at least one of the knife-edged blades is facing upward, and the knife-edged blades can move at least up or down in the mixing vessel. In one example, the lowest blade of the blade system extends to less than 50 mm from the interior bottom surface of the mixing vessel, and the rotational speed of the knife-edged blades can be adjusted to be between 500 rpm to 5000 rpm. The blade system may include a third knife-edged blade perpendicular to said two coincidental knife-edged blades. The drive shaft may be substantially inside of the mixing vessel. The blade system is, in one example, coated. The blades may be made of stainless steel and/or be a chromium or chromium alloy coated component. The angle of the drive shaft with respect to the mixing vessel is about plus or minus 5 degrees.

In particular, in one aspect, the present disclosure is a mixing device for mixing a calcium aluminate-containing slurry, comprising a mixing vessel having an interior bottom surface and interior walls, wherein the mixing vessel is configured to contain the slurry. The mixing device further comprises a motor-controlled drive shaft, wherein a first end of said drive shaft is coupled to a motor and a second end of the drive shaft is configured to extend into said mixing vessel; and a blade system attached onto said second end of the drive shaft, wherein the blade system includes at least two coincidental knife-edged blades such that at least one of the knife-edged blades is facing upward, wherein the knife-edged blades can be move up or down in the mixing vessel and the lowest blade of the blade system is less than about 50 mm from the interior bottom surface of the mixing vessel, and wherein the rotational speed of the knife-edged blades can be adjusted to be between 500 rpm to 5000 rpm.

In a further aspect, the present disclosure is directed to a mixing method. For example, the present disclosure is directed to a method for mixing a calcium aluminate and oxide particle-containing slurry. The method comprises adding a first mixture comprising calcium aluminate into a mixing vessel; deploying a motor-controlled drive shaft, comprising a first end that is coupled to a motor and a second end that is coupled to a blade system, into said mixing vessel such that the blade system is about 10 mm from the bottom of the mixing vessel. The blade system has at least two blades coincident with each other. The method further comprises turning the motor on and adjusting the speed of the blade system such that the rotation speed of the blades is from about 1500 rpm to about 3500 rpm and mixing the first mixture. Once the first mixture is mixed, the position of the blade system is adjusted such that it is from about 30 mm to about 50 mm from the bottom of the mixing vessel, and the speed of the blade system is also adjusted such that the blade speed is from about 500 rpm to about 1500 rpm. Once the blade system is in this higher position and at lower speed, a second mixture comprising oxide particles is added into the mixing vessel. This first and second mixture comprising the calcium aluminate and oxide particles are mixed inside the same mixing vessel. The blade system, in one example, rotates and the calcium aluminate slurry is mixed in the radial and rotational directions.

The method in one example comprises placing a first mixture into a mixing vessel. Once the first mixture is inside the mixing vessel, a drive shaft comprising a motor is deployed into the mixing vessel. A blade system comprising blades is attached to the drive shaft and can be driven by the motor such that the blades are in contact and mix the first mixture. The first mixture may be calcium aluminate. Before deploying a drive shaft, a second mixture may be added into the mixing vessel. This second mixture may be large scale particles comprising hollow oxide particles.

In a particular example, the present disclosure is directed to a method for mixing a calcium aluminate and oxide particle-containing slurry, comprising: adding a first mixture comprising calcium aluminate into a mixing vessel; deploying a motor-controlled drive shaft, comprising a first end that is coupled to a motor and a second end that is coupled to a blade system, said drive shaft inserted into said mixing vessel such that the blade system is about 10 mm from an interior bottom of the mixing vessel, and wherein the blade system has at least two blades coincident with each other; turning the motor on and adjusting a speed of the blade system such that a rotation speed of the blades is from about 1500 rpm to about 3500 rpm; mixing said first mixture until sufficiently mixed; adjusting a position of the blade system such that it is from about 30 mm to about 50 mm from the interior bottom of the mixing vessel, and adjusting rotation speed of the blade system such that the rotation speed of the blades is from about 500 rpm to about 1500 rpm; adding a second mixture comprising oxide particles into the mixing vessel; and mixing the first mixture and the second mixture inside the same mixing vessel, wherein the blade system rotates and mixes in radial and rotational directions.

The hollow oxide particles may comprise hollow alumina spheres. In some instances, before deploying a drive shaft, a second mixture is added into the mixing vessel comprising aluminum oxide particles, magnesium oxide particles, calcium oxide particles, zirconium oxide particles, titanium oxide particles, or combinations thereof. A second mixture comprising a ceramic, such as calcium aluminate, calcium hexaluminate, zirconia, or combinations thereof may be added into the mixing vessel.

The mixer design consists of a multiple blade system attached to a drive shaft. The drive shaft is connected to a motor and the mixer design further comprises a mixing vessel. The mixing blade and mixing vessel are used in conjunction with a powder feed system to ensure the desired rate of feed and trajectory of ceramic powder into the initial fluid. The mixing device can operate at mixing speeds from 10 rpm to 10,000 rpm.

Ceramic mixing is performed in at least two distinct stages. First stage involves ceramic cement mixing, and the secondary mixing stage involves the addition of large scale ceramic particles/aggregate. Both stages are performed in the same mixer with the same equipment. The mixing blade is typically operated at different mixing rates for the mixed properties of the ceramic mix after both the primary stage and the secondary stage. The mixing blade in one example generates a toroid in the mixing vessel. The properties of the toroid that is generated possesses the optimal shear rates, rotational velocity and axial velocity to promote break-up of the aggregates in the fine-scale ceramic, such as a calcium aluminate cement, and to ensure full mixing of every volume element of the ceramic mix.

Mixing promotes homogeneity of the mix and it reduces the viscosity to a level for making a ceramic mold for casting titanium and titanium aluminide alloys. The mixer blade comprises at least 2 vanes; in one embodiment, the blade comprises at least 3 vanes, for example 3, 4, 5, or 6 vanes. In one embodiment, the first two vanes are coincident with each other, the third vane is perpendicular to the other 2 vanes. The vanes, in one example, transfer momentum from the rotating shaft to the fluid. The term vane as used herein refers to a blade attached to a rotating axis or wheel that pushes and forms part of a machine or device such as a propeller or turbine.

When the mixing device is operational and the motor is turned on, the blade system provides a shear force to a viscosity of about 20 centipoises to about 150 centipoises. The blade system has at least two blades coincident with each other and when the motor is on and the blades are turning, the first mixture is mixed in the radial and rotational directions. Fine scale calcium aluminate may comprise the first mixture and the second mixture may comprise large hollow particles and these large scale particles are added to the first mixture. The calcium aluminate particles comprise particles of calcium monoaluminate, calcium dialuminate, and mayenite.

The first mixture comprises calcium aluminate particles of less than about 50 microns in outside dimension. The method further comprises adding a second mixture to the first mixture, wherein the first mixture comprises calcium aluminate particles of less than about 50 microns in outside dimension and the second mixture comprises oxide particles that are substantially hollow and, wherein said large scale particles comprise hollow particles of about 100 microns to about 1000 microns in outside dimension.

The drive shaft may be coated and placed substantially inside the mixing vessel, and the blades attached to the drive shaft are close to the bottom of the mixing vessel. The mixing vessel may further comprise a powder feed funnel for introducing first and second mixtures into the mixing vessel, such that the funnel has one side that is flat and when the funnel is in contact with the mixer, this flat side stays flush with the mixer. The funnel has an opening of about 20 cm to about 40 cm, and the funnel has a spout with an opening of about 7 cm through which the first mixture is added to the mixing vessel. The blade system, in one example, is attached to a shaft that extends into the mixing vessel from the top of the mixing vessel. In one embodiment, the blade system comprises at least two knife-edged blades positioned coincident to each other in the radial and rotational directions, wherein the knife-edged blades are different in size, at least one of the knife-edged blades is facing upward. In another example, the shaft with the blade system extends into the mixing vessel from the bottom of the mixing vessel. In one example, the diameter of the blade is a least 60 percent of the diameter of the vessel at the height of the vessel at which the blade is mixing the slurry. In a particular embodiment, the gap between the tip of the blades and the interior surface of the wall of the mixing vessel is less than about 15 mm. In another embodiment, this distance is less than about 30 mm. If the gap between the tip of the blades and the interior surface of the wall of the mixing vessel is large, such as greater than about 30 mm, then the mixing may be less effective and lead to improper mixing of the first and second mixtures. Accordingly, one feature of the present disclosure is a small distance, such as less than about 30 mm, between the tip of the blades and the interior surface of the wall of the mixing vessel. During the mixing, a toroid may be generated.

In one aspect, the present disclosure is directed to a blade system, comprising at least two knife-edged blades positioned coincident to each other in the radial and rotational directions, wherein the knife-edged blades are different in size, at least one of the knife-edged blades is facing upward, and further wherein the blade system is attached to the rotatable shaft. The knife-edged blades may be used for mixing a calcium aluminate-containing slurry.

One aspect of the present disclosure is directed to a blade system. The blade system comprises at least two knife-edged blades positioned coincident to each other in the radial and rotational directions, and the knife-edged blades are different in size, and at least one of the knife-edged blades is facing upward. The blade system further comprises an attaching means by which the blade system is attached to the rotatable shaft. The blade system may be attached to the rotatable shaft by any means known to an ordinary skilled artisan. In one example, a nut tack is welded on top of at least one of the knife-edged blades. The blade system may further comprise a third knife-edged blade that is perpendicular to said two coincidental knife-edged blade. The knife-edged blades may operate in the radial, r, rotational, theta, and axial, z, directions. The blade system may be coated. The blades may be made of stainless steel and/or are coated with titanium or a titanium-containing alloy. The knife-edged blades may be star-shaped. In one example, each blade of the blade system has a top surface and a bottom surface and two vanes.

The mixing device is used to mix calcium aluminate cement with hollow particles of an oxide, in one example aluminum oxide. The particles of calcium aluminate cement are significantly smaller than the large particles of aluminum oxide. In particular examples where the aluminum oxide is substantially hollow, Applicants conceived of a mixing device where two different sizes of particles can be effectively mixed together without negative effects. For example, Applicants conceived that one of the blades may predominantly be used for high shear mixing. That is, predominantly during the mixing of the calcium aluminate cement. During this stage of mixing, the inventors discovered that a rotation speed of about 1500 rpm to about 3500 rpm produces satisfactory results. That is, it was discovered that if the speed rpm value is too high during this first stage of mixing, unwanted air mixes in with the cement causing problems and low quality in the slurry and final product. On the other hand, if the speed rpm is too low at this first stage, the blade system fails to generate the necessary shear in order to break up and effectively mix the calcium aluminate cement.

During the second stage of mixing, large substantially hollow particles of aluminum oxide were added, in one example. The inventors of the instant disclosure discovered that a different blade of the blade system can more gently and effectively mix the alumina with the calcium aluminate particles. Moreover, the inventors discovered that the rotation of the blade system during this second stage of mixing (mixing in of oxide particles), it is better to reduce the speed rpm of the blade system to about 500-1500 rpm. It was discovered that if at this stage, where large hollow alumina particles are added into the calcium aluminate mixture, the speed rpm is too high (e.g. 3000 rpm), unwanted air is introduced into the system and the large hollow particles become damaged and break up. On the other hand, however, if the speed rpm is well below 500 rpm, the large hollow particles of alumina were found not to effectively mix with the first mixture and did not produce a sufficient mixture. Thus, the inventors of the instant disclosure found that during this stage, about 500 rpm to about 1500 rpm produced highly desirable results.

The nature of the blades and the speed at which they operate are features of the present disclosure. In particular, in one example, the horizontal blade is used predominantly in the breakup of aggregates that form in the mixture and the non-horizontal blade provides for axial flow of the mixture. Operation of the blade system generates a toroid (3D torus) in which there are large shear forces within the toroid. The blade system itself can be about 10 mm from the bottom of the mixing vessel. This is used during operation of the motor when the first mixture is being mixed and high shear mixing is necessary. During this stage, it was found that blade rotation speeds of about 1500 rpm to about 3500 rpm were necessary.

During the second stage of mixing where the large scale hollow alumina particles were added, the shaft was lifted such that the blade system was from about 30 mm to about 50 mm from the bottom of the mixing vessel. It was found that the rotation speed of the blades at this stage of mixing is most effective when at from about 500 rpm to about 1500 rpm. During operation of the motor, in one example, a toroid is formed that allows for large shear forces within the toroid and therefore for effective mixing of the mixture, for example the first mixture. The blades themselves may be coated, as may the shaft itself. The coating of the shaft, for example with Teflon-containing components, allowed for a substantial reduction in the build up of material on the shaft during or immediately after the mixing process.

The blades rotate in the radial, r, rotational, theta, and axial, z, directions and drive flow of the mix in these directions and generate the resulting mixing shear that is used to break up the cement agglomerates. This also ensures full mixing of every element of the ceramic mix during both stages of mixing: the primary calcium aluminate mixing stage and the secondary mixing stage involving the large scale particles.

The mixing method involves first mixing fine-scale (less than 50 microns) calcium aluminate to the desired viscosity, and second adding larger-scale (greater than 50 microns) ceramic aggregate to the initial cement mix. In one formulation, calcium aluminate cement of a size of less than 50 microns is mixed to a viscosity of approximately 100 centipoise, and then alumina particles are added that are greater than 50 microns, typically 500-1000 microns, and the ceramic mix is mixed to an acceptable level of uniformity and then used to make a casting mold.

The present disclosure involves a novel mixing device and a new mixing method for casting titanium and titanium aluminide alloys. The new mixer design consists of a multiple blade system attached to a drive shaft and a motor, and a mixing vessel. The mixing blade and mixing vessel are used in conjunction with a powder feed system to ensure the desired rate of feed of ceramic powder into the initial fluid at a designated location in the moving fluid.

Ceramic mixing is performed in at least 2 stages; the first stage involves ceramic cement mixing, and a secondary mixing stage involving the large scale ceramic particles/aggregate. Both stages are performed in the same mixer with the same equipment, but operating the mixing blade at different mixing rates to ensure the sufficient properties of the ceramic mix after both stages.

The first mixture may comprise calcium aluminate particles of less than about 50 microns in outside dimension. The method of the present disclosure further comprises adding a second mixture to the calcium aluminate, wherein the first mixture comprises particles of calcium aluminate that are less than about 50 microns in outside dimension and the second mixture comprises oxide particles that are substantially hollow particles of about 100 microns to 1000 microns in outside dimension.

In operation according to one example, the mixing blade is in contact with the first and second mixture and generates a toroid of the mix in the mixing vessel. The properties of the toroid that is generated are a feature of the present disclosure; the toroid possesses high shear rates, high rotational velocity, and axial velocity to promote break-up of aggregates in the fine-scale ceramic, such as a calcium aluminate cement, and to ensure full mixing of every volume element of the mix. The calcium aluminate may be in the form of fine scale calcium aluminate and the second mixture comprising large hollow particles are added to the calcium aluminate (first mixture). The calcium aluminate particles comprise, in one example, particles of calcium monoaluminate, calcium dialuminate, and mayenite.

The blade system in one example provides shear forces to the first mixture (calcium aluminate and water) such that a viscosity of about 20 centipoises to about 150 centipoises is achieved. In another example, the blade system can provide shear forces to the second mixture (calcium aluminate, water and oxide particles) such that a viscosity of about 20 centipoises to about 5000 centipoises is achieved. The blade system has, in one example, at least two blades coincident with each other and when the motor is on and the blades are turning, the first mixture is mixed in the radial and rotational directions. In one example, the mixer blade consists of at least 2 vanes; in one example, the blade consists of 3 vanes. The first 2 vanes are coincident with each other in the radial and rotational directions, and the third vane is perpendicular to the other 2 vanes.

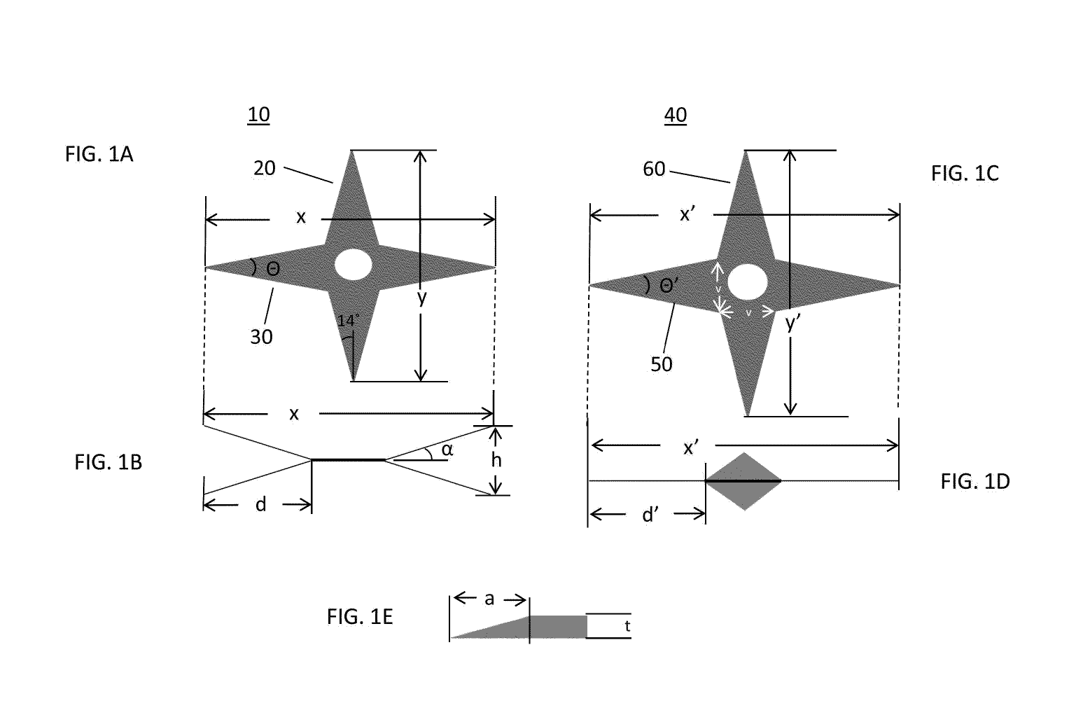

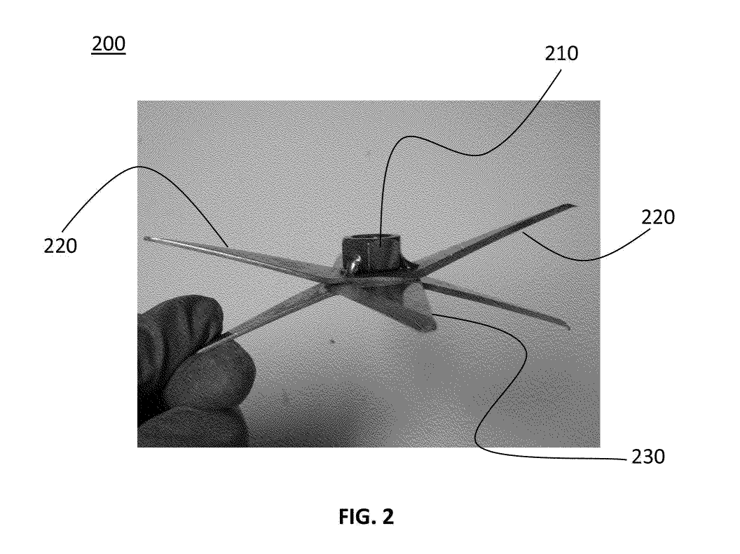

The blade design according to one example is shown in FIGS. 1 and 2. As noted, the blade system in one example has straight blades and angled blades with corresponding properties and dimensions.

According to one embodiment noted in FIG. 1A, the angled blade 10 of the blade system has straight blade portion 20 and angled blade portion 30. The dimensions of the angled blade 10 in this example have a first dimension x and a second dimension y that define the distances from the points of the angled blade 10 for the angled blade portion and straight blade portion respectively. In one example, for illustrative purposes, x is 4.20 inches and y is 4.38 inches. The angular geometry theta (8) of the angled blade 10 as measured at the point is about 28 degrees in this example. The dimensions of the angled blade 10 can vary depending upon factors such as the application and mixing environment, including the size of the container in which the blade is used to mix the material.

FIG. 1B shows the projection side of the angled blade 10 according to this example. The distance d in this example is 1.64 inches and the angle of the projection (α) which in this example is about 18 degrees.

In another example, the straight blade 40 shown in FIG. 1C includes different dimensions x′ and y′. The straight blade 40 includes straight blade portion 50 and angled blade portion 60. In one example the x′ dimension is 4.38 inches and the y′ dimension is 4.2 inches. The interior dimension of the blade (v) in this example is 0.88 inches. FIG. 1D shows the projection side of the straight blade 40 according to this example. The distance d′ in this example is 1.73 inches. The dimensions of the straight blade 40 can vary depending upon factors such as the application and mixing environment, including the size of the container in which the blade is used to mix the material.

The profile of the leading edge blade is depicted in FIG. 1E, and illustrates that in this example the blade thickness (t) is about 0.050 inches and that the knife edge profile length (a) is about 0.165 inches.

Referring to FIG. 2, this perspective view illustrates the mixing blade 200 according to one embodiment showing the nut 210 that is secured to the two angled blades 220 and the straight blade 230.

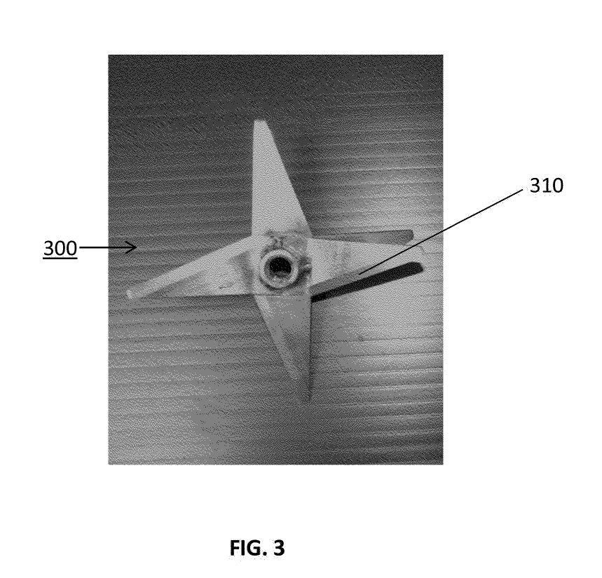

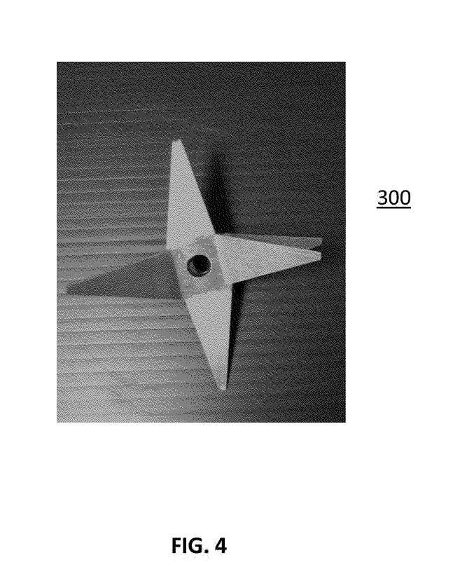

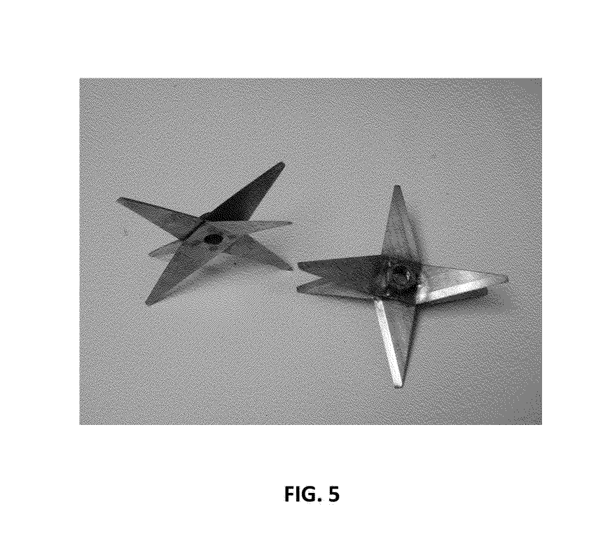

FIG. 3 illustrates the top of the blade system 300 and in particular the slope 310 of the knife edge blade. FIG. 4 shows the bottom of the blade system, wherein in operation according to one embodiment removes any stagnation zones below the blade in the mixing vessel.

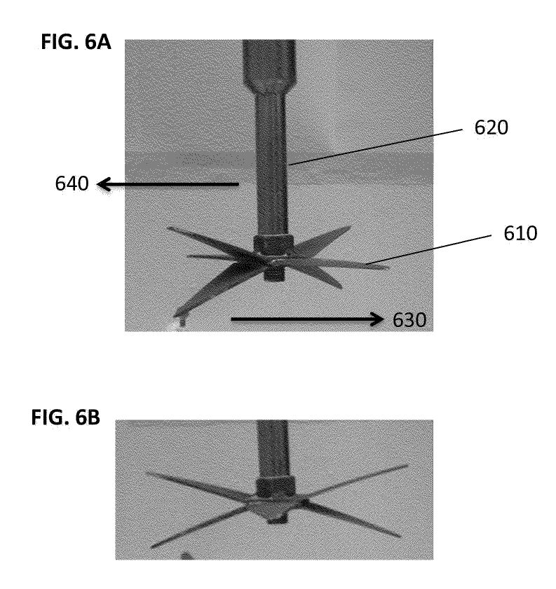

Referring to FIG. 6A, this shows a side perspective view of the blade assembly 610 having three blades and mounted on the mixing shaft 620 prior to insertion in the mixing vessel. The arrow 630 indicates that the blade screws and tightens onto shaft 620 in the counterclockwise direction. Arrow 640 indicates the blade and shaft spinning clockwise while mixing. FIG. 6B shows another side perspective view of the blade assembly from a closer range.

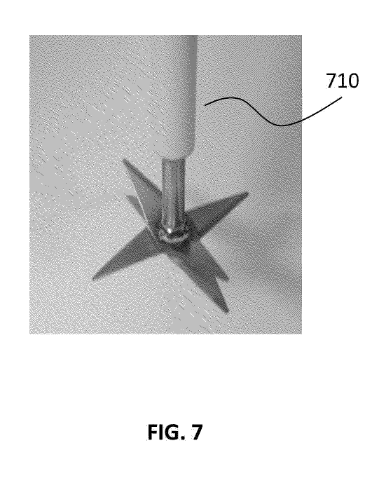

Referring to FIG. 7, the blade assembly is shown mounted on the mixing shaft prior to insertion in the mixing vessel with a Teflon coated mixing shaft 710. The coating helps to prevent build up of slurry on the mixing shaft and can cover some or all of the mixing shaft.

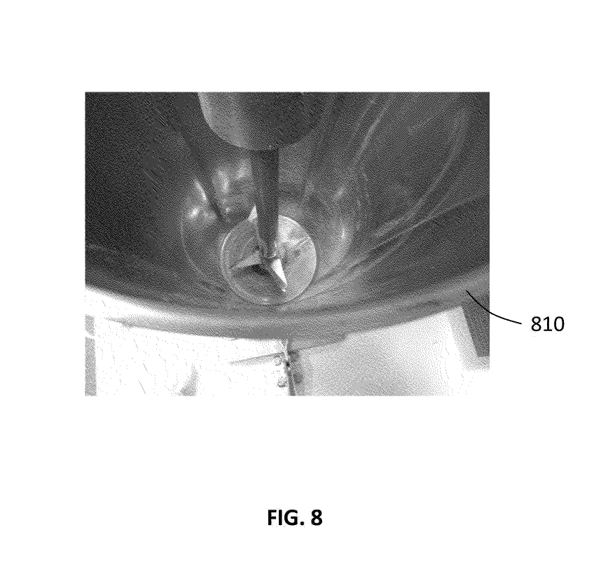

FIG. 8 shows the blade assembly mounted on the mixing shaft and inserted in the stainless steel mixing vessel 810. In this example, the diameter of the mixing vessel is not considerably greater than the dimensions of the mixing blade in order to provide improved mixing.

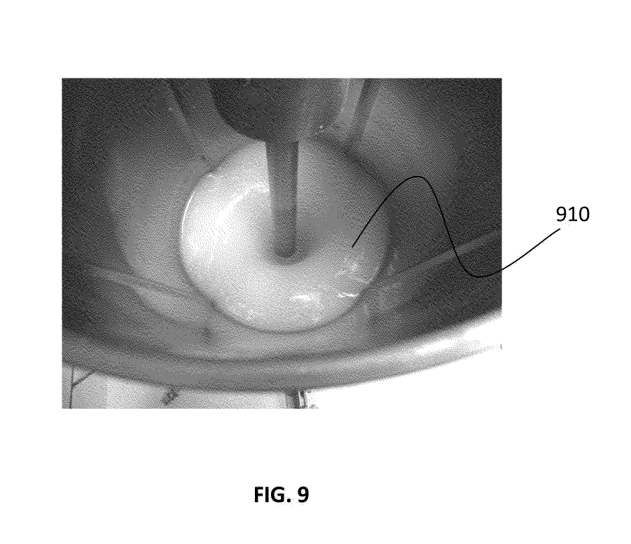

Referring to FIG. 9, the blade assembly is shown mounted on the mixing shaft and inserted in the stainless steel mixing vessel, wherein the mixer is being used to mix the water and colloidal silica 910.

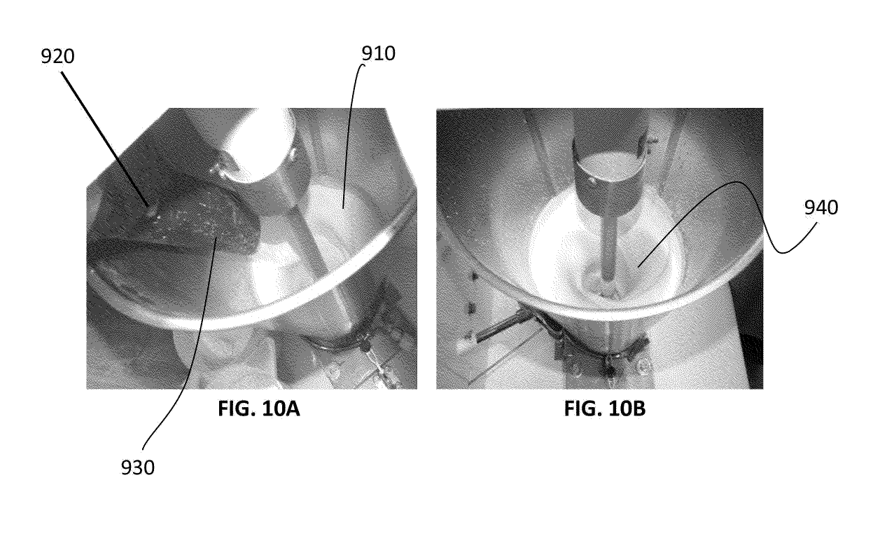

FIG. 10A shows the blade assembly mounted on the mixing shaft and mixing the water and colloidal silica 910 as well as depicting a funnel 920 that is used to feed calcium aluminate cement 930 into the mix.

FIG. 10B shows the blade assembly mounted on the mixing shaft and mixing the slurry 940 that consisted of calcium aluminate cement, water, and colloidal silica.

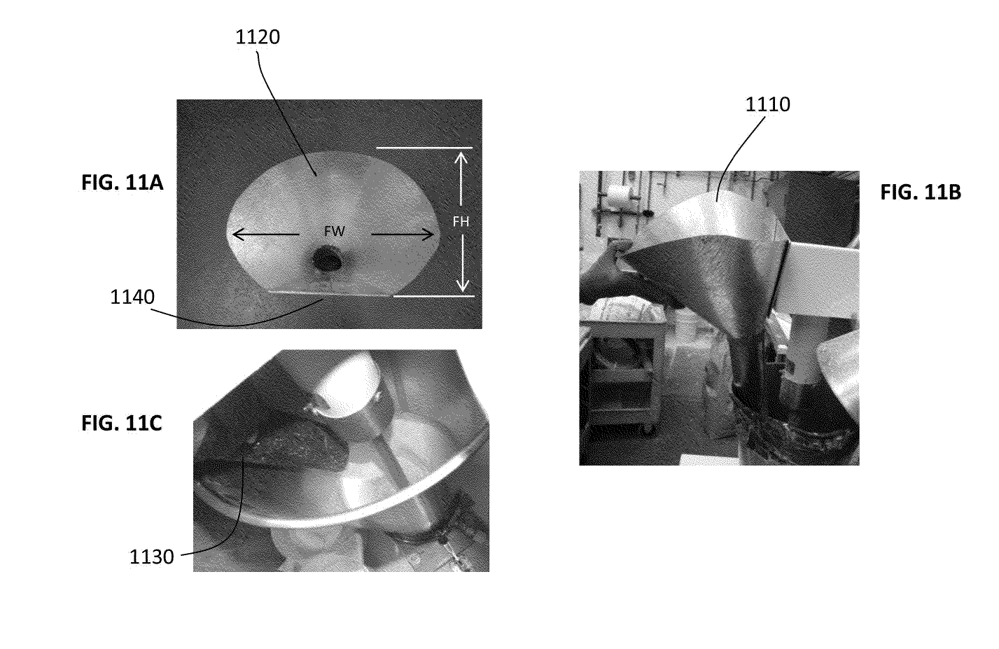

Referring to FIGS. 11A-11C, the funnel feed 1110 is shown in relation to the position to the mixing assembly, wherein the funnel feed 1110 has a funnel portion 1120 and a spout 1130 used to introduce components into the mixing vessel. In one example the funnel portion 1120 is oval shaped and has a funnel width (FW) about 35 centimeters and a funnel height (FH) of about 26 centimeters. The spout 1130 has dimensions to provide for precision entry of the cement into the vortex, yet large enough to prevent clogging. In this example the funnel portion includes a flat section 1140 that helps maintain the funnel in position when coupled to the mixing system.

The motion of the blades in the radial, r, rotational, theta, and axial, z, directions drive flow of the mix in these directions and generate the resulting mixing shear that is used to break up the cement agglomerates and ensure full mixing of every element of the ceramic mix during both stages of mixing; the primary cement mixing stage, and the secondary mixing stage involving the large scale ceramic particles/aggregate.

The blade system may further comprise the nut tack welded on top of one of the blades. The two coincidental blades of the blade system may not be the same size. The blades of the blade system may be made of stainless steel or titanium coated stainless steel. The blade system may be coated, for example, with chromium or chromium-containing alloy. The blades of the blade system may be arranged such that they are in a star-shaped configuration. Each blade of the blade system may have a top surface and a bottom surface and two vanes. In one example, when the blade system is operating, the motion of the blades are in the radial, r, rotational, theta, and axial, z, directions. The angle of the drive shaft with respect to the mixing vessel may be about 90 degrees; that is the drive shaft is substantially vertical compared to the horizontal bottom surface of the mixing vessel.

The blade system may be about 10 mm from the bottom of the mixing vessel. During operation of the motor, the rotation speed of the blades may be from about 1500 rpm to about 3500 rpm; this range is used for example to mix the initial calcium aluminate slurry. The blade system may be from about 30 mm to about 50 mm from the bottom of the mixing vessel. The blade system may, in one example, be from about 6 cm to about 12 cm from the bottom of the mixing vessel. In another example, before the second mixture of large scale hollow particles are mixed in, the blade system is lifted to about 11 cm from the bottom of the mixing vessel. During operation of the motor, the rotation speed of the blades may be from about 500 rpm to about 1500 rpm; this range is used for example to mix the first and second mixtures (the calcium aluminate with the hollow oxide particles). According to one embodiment, the mixing process is improved and the vortex is generated when the distance between the mixing blades and the bottom of the mixing vessel is between about 30 mm to about 50 mm.

Aspects of the present disclosure provide methods of casting using a novel apparatus. Though some aspect of the disclosure may be directed toward the fabrication of components for the aerospace industry, for example, engine turbine blades, aspects of the present disclosure may be employed in the fabrication of any component in any industry, in particular, those components containing titanium and/or titanium alloys.

The large scale particles may comprise particles that are more than about 50 microns in outside dimension. For example, the large scale particles may comprise particles of about 50 microns to about 300 microns in outside dimension. In one example, at least 50% of the calcium aluminate particles are less than about 10 microns in outside dimension. In another example, the calcium aluminate particles comprise particles of up to about 50 microns in outside dimension, and the large scale particles comprise particles of from about 70 to about 300 microns in outside dimension. In one embodiment, the weight fraction of the calcium aluminate particles is greater than about 20% and less than about 80%. In another embodiment, the weight fraction of the large scale particles is from about 20% to about 65%.

Another aspect of the present disclosure is a method for making a casting mold for casting a hollow titanium-containing article. The method comprises combining calcium aluminate particles, large scale particles and a liquid to produce a slurry of calcium aluminate particles and large scale particles in the liquid; introducing the slurry into a mold cavity that contains a fugitive pattern; and allowing the slurry to cure in the mold cavity to form a mold of a titanium-containing article. In one embodiment, fine scale calcium aluminate particles are used, along with large scale particles that are substantially hollow.

The method further comprises introducing oxide particles to the slurry before introducing the slurry into a mold cavity. The oxide particles that are used in the presently taught method comprise aluminum oxide particles, magnesium oxide particles, calcium oxide particles, zirconium oxide particles, titanium oxide particles, or combinations thereof. In one embodiment, the oxide particles used in the presently taught method comprise hollow oxide particles. In a particular example, the oxide particles comprise hollow alumina spheres.

Large scale particles can include, for example, aluminum oxide. In one example, the large scale particles are hollow particles. These hollow particles may comprise about 99% of an oxide (e.g. aluminum oxide) and have about 10 millimeter [mm] or less in outside dimension, such as, width or diameter. In one embodiment, the hollow oxide particles have about 1 millimeter [mm] or less in outside dimension, such as, width or diameter. In another embodiment, the oxide comprises particles that may have outside dimensions that range from about 70 microns [μm] to about 10,000 microns. In another embodiment, the oxide comprises particles that may have outside dimensions that range from about 70 microns [μm] to about 300 microns.

Embodiments of the present disclosure provide ceramic compositions and casting methods that provide hollow titanium and titanium alloy components for example, for use in the aerospace, industrial and marine industry. In some aspects, the mold provides improved mold strength during mold making and/or increased resistance to reaction with the casting metal during casting. The molds according to aspects of the disclosure may be capable of casting at high pressure, which is desirable for near-net-shape casting methods. Mold compositions, for example, containing calcium aluminate particles and alumina particles, and the constituent phases, have been identified that provide castings with improved properties.

Accordingly, the present disclosure addresses the challenges of producing a mold, for example, an investment mold, that does not react significantly with titanium and titanium aluminide alloys. In addition, according to some aspects of the disclosure, the strength and stability of the mold allow high pressure casting approaches, such as centrifugal casting. One of the technical advantages of this disclosure is that, in one aspect, the disclosure may improve the structural integrity of net shape casting that can be generated, for example, from calcium aluminate particles and alumina investment molds. The higher strength, for example, higher fatigue strength, allows lighter components to be fabricated. In addition, components having higher fatigue strength can last longer, and thus have lower life-cycle costs.

The weight fraction of calcium aluminate particles used in the present method is a feature of the present disclosure. In one embodiment, the weight fraction of calcium aluminate particles is from about 20% to about 80%. In one embodiment, the weight fraction of calcium aluminate particles is from about 20% to about 60%. In one embodiment, the weight fraction of calcium aluminate particles is from about 20% to about 40%. In one embodiment, the weight fraction of calcium aluminate particles is from about 40% to about 60%. In one embodiment, the weight fraction of calcium aluminate particles is from about 55% to about 65%.

In one embodiment, the weight fraction of calcium aluminate particles is about 40%. In one embodiment, the weight fraction of calcium aluminate particles is about 50%. In one embodiment, the weight fraction of calcium aluminate particles is about 60%. In one embodiment, the weight fraction of calcium aluminate particles is about 70%. In one embodiment, the weight fraction of calcium aluminate particles is about 80%.

In one example, the particle size of the calcium aluminate particles is less than about 50 microns. In another example, the mean particle size of the calcium aluminate particles is less than about 10 microns. In one embodiment, the particle size is measured as the outside dimension of the particle. The calcium aluminate particles can be from about 5 microns to about 50 microns in outside dimension.

In one aspect, the mold composition, for example, the investment mold composition may comprise a mixture of calcium aluminate particles and alumina particles. The calcium aluminate particles may function as a binder, for example, the calcium aluminate particles may provide the main skeletal structure of the mold and core structure. The calcium aluminate particles may comprise a continuous phase in the mold and provide strength during curing, and casting. The second mixture may consist of fine scale calcium aluminate particles and large scale hollow alumina particles, that is, calcium aluminate and large scale alumina particles may comprise substantially the only components of the second mixture, with little or no other components.

In one example, the particle size of large scale particles is about 70 microns to about 300 microns in outside dimension. These large scale particles may comprise hollow oxide particles. The large scale particles may comprise aluminum oxide particles, magnesium oxide particles, calcium oxide particles, zirconium oxide particles, titanium oxide particles, or combinations thereof. The large scale particles can be a ceramic, such as calcium aluminate, calcium hexaluminate, zirconia, or combinations thereof. In one embodiment, the oxide particles may be a combination of one or more different oxide particles. In a particular example, the large scale particles are hollow oxide particles, and in a related example, these large scale particles comprise hollow aluminum oxide spheres or bubbles. In one embodiment, the present disclosure comprises a hollow titanium-containing article casting-mold composition comprising calcium aluminate. In another embodiment, the casting-mold composition further comprises oxide particles, for example, hollow oxide particles.

In certain embodiments, the hollow oxide particles may comprise hollow alumina spheres (typically greater than 100 microns in diameter). The hollow alumina spheres may be incorporated into the casting-mold, and the hollow spheres may have a range of geometries, such as, round particles, or irregular aggregates. In certain embodiments, the alumina may include both round particles and hollow spheres. In one aspect, these geometries were found to increase the fluidity of the investment mold mixture. The enhanced fluidity may typically improve the surface finish and fidelity or accuracy of the surface features of the final casting produced from the mold.

Surface roughness is one of the indices representing the surface integrity of cast and machined parts. Surface roughness is characterized by the centerline average roughness value “Ra”, as well as the average peak-to-valley distance “Rz” in a designated area as measured by optical profilometry. A roughness value can either be calculated on a profile or on a surface. The profile roughness parameter (Ra, Rq, . . . ) are more common. Each of the roughness parameters is calculated using a formula for describing the surface. There are many different roughness parameters in use, but Rₐ is by far the most common. As known in the art, surface roughness is correlated with tool wear. Typically, the surface-finishing process though grinding and honing yields surfaces with Ra in a range of 0.1 mm to 1.6 mm. The surface roughness Ra value of the final coating depends upon the desired function of the coating or coated article.

The average roughness, Ra, is expressed in units of height. In the Imperial (English) system, 1 Ra is typically expressed in “millionths” of an inch. This is also referred to as “microinches”. The Ra values indicated herein refer to microinches. An Ra value of 70 corresponds to approximately 2 microns; and an Ra value of 35 corresponds to approximately 1 micron. It is typically required that the surface of high performance articles, such as turbine blades, turbine vanes/nozzles, turbochargers, reciprocating engine valves, pistons, and the like, have an Ra of about 20 or less. One aspect of the present disclosure is a turbine blade comprising chromium or chromium alloy and having an average roughness, Ra, of less than 20 across at least a portion of its surface area.

Furthermore, the present disclosure also teaches a method for making a casting mold for casting a hollow titanium-containing article. The method comprises combining calcium aluminate particles, large scale particles and a liquid to produce a slurry, introducing this slurry into a mold cavity that contains a fugitive pattern, and allowing it to cure in the mold cavity. The method may further comprise introducing oxide particles to the slurry before introducing the slurry into a mold cavity.

By hollow, it is contemplated that these large scale particles are particles that have space or pockets of air within the particle(s) such that the particle is not a complete, packed dense particle (that is, less than 100% theoretical density). The degree of this space/air varies and hollow particles include particles where at least 20% of the volume of the particle is air. In one example, hollow particles are particles where about 5% to about 95% of the volume of the particle is made up of empty space or air. In another example, hollow particles are particles where about 10% to about 90% of the volume of the particle is made up of empty space or air. In yet another example, hollow particles are particles where about 20% to about 80% of the volume of the particle is made up of empty space or air. In another example, hollow particles are particles where about 30% to about 70% of the volume of the particle is made up of empty space or air. In another example, hollow particles are particles where about 40% to about 60% of the volume of the particle is made up of empty space or air.

In another example, hollow particles are particles where about 10% of the volume of the particle is made up of empty space or air. In one example, hollow particles are particles where about 20% of the volume of the particle is made up of empty space or air. In one example, hollow particles are particles where about 30% of the volume of the particle is made up of empty space or air. In one example, hollow particles are particles where about 40% of the volume of the particle is made up of empty space or air. In one example, hollow particles are particles where about 50% of the volume of the particle is made up of empty space or air. In one example, hollow particles are particles where about 60% of the volume of the particle is made up of empty space or air. In one example, hollow particles are particles where about 70% of the volume of the particle is made up of empty space or air. In one example, hollow particles are particles where about 80% of the volume of the particle is made up of empty space or air. In one example, hollow particles are particles where about 90% of the volume of the particle is made up of empty space or air.

One aspect of the present disclosure is a method for forming a casting mold for casting a hollow titanium-containing article, the method comprising: combining calcium aluminate with a liquid to produce a slurry of calcium aluminate, wherein the percentage of solids in the initial calcium aluminate/liquid mixture is about 70% to about 80% and the viscosity of the slurry is about 50 to about 150 centipoise; adding large scale hollow oxide particles into the slurry such that the solids in the final calcium aluminate/liquid mixture with the large-scale (greater than about 70 microns) oxide particles is about 75% to about 90%; introducing the slurry into a mold cavity that contains a fugitive pattern; and allowing the slurry to cure in the mold cavity to form a mold of a hollow titanium-containing article.

The solidified hollow titanium or titanium alloy casting is then removed from the mold. In one embodiment, after removing of the titanium or titanium alloy from the mold, the casting may be finished with grit blasting or polishing. In one embodiment, after the solidified casting is removed from the mold, it is inspected by X-ray or Neutron radiography. The disclosure also teaches titanium or titanium alloy articles, e.g. a turbine blade, made by the casting method as taught herein.

The second mixture may comprise fine scale calcium aluminate and large scale particles. The large scale particles can be hollow. The calcium aluminate particles may comprise particles of calcium monoaluminate, calcium dialuminate, and mayenite. The selection of the correct calcium aluminate particle chemistry and alumina formulation are factors in the performance of the presently taught method. In one embodiment, the first mixture further comprises calcium oxide. In terms of the calcium aluminate particles of the mixture, it may be necessary to minimize the amount of free calcium oxide in order to minimize reaction with the titanium alloy.

The second mixture, in one example, comprises large scale hollow oxide particles. The hollow oxide particles may comprise hollow alumina spheres. A second mixture may be added into the mixing vessel and mixed with the first mixture. This second mixture may comprise aluminum oxide particles, magnesium oxide particles, calcium oxide particles, zirconium oxide particles, titanium oxide particles, or combinations thereof. A second mixture may be added into the mixing vessel comprising a ceramic, such as calcium aluminate, calcium hexaluminate, zirconia, or combinations thereof.

If the calcium oxide concentration is less than about 10% by weight, the alloy reacts with the mold because the alumina concentration is too high, and the reaction generates undesirable oxygen concentration levels in the casting, gas bubbles, and a poor surface finish in the cast component. Free alumina is less desirable in the mold material because it can react aggressively with titanium and titanium aluminide alloys. In one embodiment, the calcium oxide concentration of the casting mold is between 10% and 50% by weight. In one embodiment, a third mixture is added to the mixing vessel comprising 10% and 50% by weight of calcium oxide.

The present disclosure provides a casting mold composition and a casting process that can provide improved components of titanium and titanium alloys, in particular hollow titanium turbine blades. External properties of the casting include features such as shape, geometry, and surface finish. Internal properties of the casting include mechanical properties, microstructure, and defects (such as pores and inclusions) below a certain size.

### EXAMPLES

The disclosure, having been generally described, may be more readily understood by reference to the following examples, which are included merely for purposes of illustration of certain aspects and embodiments of the present disclosure, and are not intended to limit the disclosure in any way.

Aspects of the present disclosure provide ceramic core compositions, methods of casting, and cast articles that overcome the limitations of the conventional techniques. Though some aspect of the disclosure may be directed toward the fabrication of components for the aerospace industry, for example, engine turbine blades, aspects of the present disclosure may be employed in the fabrication of any component in any industry, in particular, those components containing titanium and/or titanium alloys.

In one example, a slurry mixture for making an investment mold consisted of 5416 g of a fine-scale calcium aluminate cement, 2943 g of high-purity alumina bubble of a size range from 0.5-1 mm diameter, 1641 g of deionized water, and 181 g of Remet colloidal silica LP30. A blender cup was used with a height of 381 mm, a top opening of 280 mm, a bottom diameter of 127 mm, and the width of the mixing blade used was about 112 mm.

The mixing method involves first mixing fine-scale (less than 50 micron) cement to the correct viscosity, and second adding larger-scale (greater than 50 micron) ceramic aggregate of high-purity alumina bubble to the initial cement mix. In the first stage of mixing the water and colloidal silica were mixed at a rotational speed of 3000 rpm using the mixing vessel and mixing blade that are shown in FIGS. 2 and 8. The height of the mixer blade above the base mixing vessel was set at 10 mm. After the water and colloidal silica were fully mixed, the fine scale cement was added in a controlled manner to generate a slurry with a solids loading of approximately 70 per cent.

The slurry was mixed for approximately 6 minutes at which point it possessed a viscosity of about 100 centipoise. At this point the mix blade rotational speed was reduced to 1000 rpm and the alumina bubble was added to the slurry in a controlled manner. The height of the mixer blade above the base mixing vessel was set at 11 cm. After 2943 g of high-purity alumina bubble was added to the slurry, the complete ceramic mix was mixed at 1000 rpm for 1 minute to ensure full mixing of the calcium aluminate-containing slurry and the alumina bubble.

After mixing, the investment mold mix was poured in a controlled manner into a vessel that contains the fugitive wax pattern, as described in the first example. The solids loading of the initial cement slurry mixture with all components without the large-scale alumina particles is 70 per cent. The solids loading of the final mold mix is about 82 per cent. The mold was then cured and fired at high temperature. The produced mold was used for casting titanium aluminide-containing articles such as turbine blades.

The blade material was stainless steel. The blade thickness was 1.25 millimeters±0.05 millimeters (excluding sharpened knife edge). The surface roughness of the blade was less than 5 Ra value, and the hardness of the blade was Rockwell Hardness C of greater than about 50.

Tungsten carbide coatings were used in some examples. In such examples, the coating was about 60 microns to about 80 microns thick (plus or minus 20 microns), the hardness was about 70 to about 75 Rockwell Hardness C.

In one example, the coating of the blade had the following properties: the thickness of the coating was about 100 μm to about 800 μm; the surface roughness (Ra) was approx. 0.2 μm (mech. refinished) to 30 μm; and the hardness was 53 to 70 Rockwell Hardness C.

In one embodiment, the mixer shaft had a Teflon film coating. This coating is to prevent build up of mold mix on the shaft. The shaft was wiped clean with a wet cloth after each cycle.

### EXAMPLES OF CERAMIC MOLD FORMULATION MIXING DEVICES

In the following examples a series of mixing devices are described that were used to produce ceramic mold mixes for making molds for casting titanium alloys, including titanium aluminide-based alloys. Each mixing device was evaluated against a set of criteria, as shown in Table 1 below. Examples 1 and 5 show devices under various testing conditions and the corresponding effectiveness.

### Example #1

### Lower Motor and Shaft with Open Knife Blade

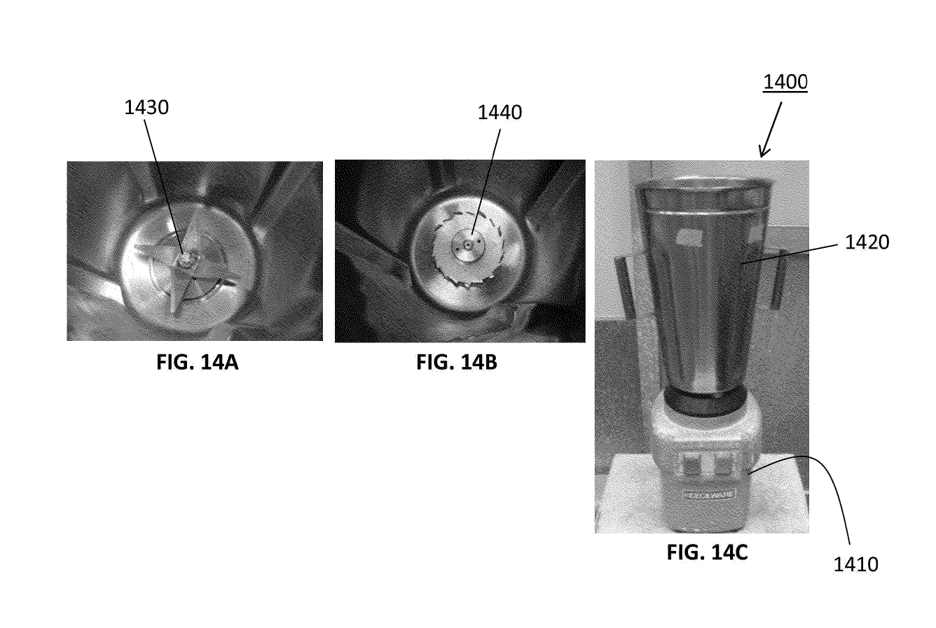

In one example, a ceramic mold formulation mixing machine was developed with a lower motor and shaft, as shown in the FIGS. 14A-14C. The motor is positioned in a lower motor assembly 1410 below the mixing vessel 1420, wherein the lower motor assembly 1410 is configured to receive and retain the mixing vessel 1420. The mixing machine 1400 consists of a drive motor and shaft within the lower motor assembly 1410 and a coupling that connects to a drive gear on the base of the mixing vessel 1420. The drive gear is connected to a shaft that transmits the torque of the drive motor through the base of the mixing vessel to the mixing blade 1430, 1440 that is used to mix the ceramic mold formulation. The drive coupling and sealing arrangement at the base of the mixing vessel are features of the present disclosure. The drive shaft is sealed in the coupling to prevent leakage of the ceramic slurry out of the base of the vessel. FIG. 14A shows the open knife blade design 1430 while FIG. 14B shows the Cowles blade design 1440.

In operation according to one example such as shown in FIG. 14A, the lower motor mixer assembly 1410 with the shaft and blade was operated at rotational speeds up to and above 3000 rpm and this generates a mixing torus of the fluid being mixed within the mixing vessel with high fluid velocities and significant shear forces within the slurry.

The geometry of the mixing vessel 1420 and the geometry of the open mixing blade 1430 and the mixing torus generated are selected to ensure full mixing of every volume element of the ceramic mold formulation, and to minimize the possibility of recirculation/stagnation zones in the ceramic mold formulation during mixing.

The blade system 1430 was attached onto the drive shaft wherein the blade system included at least two coincidental knife-edged blades such that at least one of the knife-edged blades was facing upward. In one embodiment, the blade system included a third knife-edged blade perpendicular to the two coincidental knife-edged blades.

Powder feeding into the mixing torus is straightforward and there is open access to the mixing torus. In one embodiment, a uniform mix of consistent viscosity is generated, with no visible residual aggregates, and a minimum volume of air bubbles.

One advantage of lower motor type of mixing is that the mixing machine produced acceptable reduction in the size of the cement agglomerates, and acceptable slurry viscosity. The mixing machine introduces minimal air into the slurry mix. Controlled addition of powder to the mixing torus is facilitated by the open access to the mix in the absence of an exposed mixing shaft. Another advantage of this type of mixing is that there is no build up of splatter on the blade that can lead to incomplete mixing or unacceptable agglomerates in the mix. Yet another advantage of this type of mixing is that the geometry of the mixing vessel and the geometry of the mixing blade are selected to ensure full mixing of every volume element of the ceramic mold formulation, and to minimize the possibility of any recirculation/stagnation zones. The machine is fast and efficient and the mixing vessel can be easily cleaned.

One disadvantage of the lower motor type of mixing is that the heat from the motor beneath the mixing blade can increase the temperature of the mix, which can be undesirable during subsequent curing of the mold. In one example, the cement slurry temperature is kept below 30 degrees Celsius. Another disadvantage of this type of mixing is that the shaft coupling performance and the performance of the seals in the base of the mixing vessel can become compromised as a result of the seals becoming penetrated by the fine cement powder. The powder can cause wear of the shaft and the seals, and, as a result, the cement slurry can leak from the bottom of the mixing vessel. This is a result of the high fluid velocities beneath the open knife blade, in the region between the base of the mixing blade and the bottom of the mixing vessel. Yet another disadvantage of this type of mixing is that it is difficult to perform the 2-stage mixing of the initial calcium aluminate cement followed by the bubble with the fixed blade position and the mixing vessel geometry. With the fixed blade height above the base of the mixing vessel, it is difficult to effectively mix the large-scale aggregate into the cement slurry as the viscosity and volume of the mix increases. The blade in the base of the mixing vessel makes cleaning of the blade and the mixing vessel more difficult, which adds to one of the disadvantages of this approach.

Molds were made with the following formulation and mixing method:

A slurry mixture for making an investment mold consisted of 5416 g of a fine-scale calcium aluminate cement, 2943 g of high-purity alumina bubble of a size range from 0.5-1 mm diameter, 1641 g of deionized water, and 181 g of Remet colloidal silica LP30. A mixing vessel was used with a height of 381 mm, a top opening of 280 mm, a bottom diameter 127 mm, and the width of the mixing blade used was about 112 mm for the open knife blade design.

The mixing method involved first mixing fine-scale (less than 50 micron) calcium aluminate cement with water and colloidal silica to the correct viscosity, and second adding larger-scale (greater than 50 micron) ceramic aggregate of high-purity alumina bubble to the initial cement slurry mix. In the first stage of mixing, the water and colloidal silica were mixed at a rotational speed of 3000 rpm using the mixing vessel and mixing blade. The height of the mixing blade above the base mixing vessel was set at 20 mm; this is the maximum for the vessel-coupling seal that was used. After the water and colloidal silica were fully mixed, the fine-scale cement was added in a controlled manner to generate a slurry with a solids loading of approximately 70 per cent.

The slurry was mixed for approximately 6 minutes at which point it possessed a viscosity of about 100 centipoise. At this point, the cement slurry was transferred to a second lower-speed mixer to mix the larger-scale alumina aggregate into the ceramic mix. In the second, lower-speed mixer, the blade rotational speed was reduced to less than 1000 rpm and the alumina bubble was added to the slurry in a controlled manner. After 2943 g of high-purity alumina bubble was added to the slurry, the complete ceramic mix was mixed to ensure full mixing of the calcium aluminate-containing slurry and the alumina bubble, but to avoid any attrition of the large alumina particles.

After mixing, the investment mold mix was poured in a controlled manner into a vessel that contained the fugitive wax pattern. The solids loading of the initial cement slurry mixture with all components without the large-scale alumina particles is 70 per cent. The solids loading of the final mold mix is about 82 per cent. The mold was then cured and fired at high temperature. The produced mold was used for casting titanium aluminide-containing articles such as turbine blades. The molds so produced were of sufficient quality and they were used for casting Titanium Aluminide based alloys.

### Example #2

### Lower Motor and Shaft with Open Cowles Blade

In another example, a ceramic mold formulation lower motor mixing machine 1410 was developed with a Cowles blade 1440 and a lower motor and shaft such as shown in FIG. 14B. The Cowles blade design is often used for mixing powders into fluids, and is a well-accepted design in the industry. The blade is often employed for dispersing fine powder into fluids and is sometimes referred to as a dispersing blade. The Cowles blade is designed to generate high shear levels to break up powder agglomerates in mixing applications such as wetting out powders, dispersing fine solids, and creating emulsions.

The lower mixing machine 1410 consists of a drive motor and shaft and a coupling that connects to a drive gear on the base of the mixing vessel. The drive gear is connected to a shaft that transmits the torque of the drive motor through the base of the mixing vessel 1420 to a mixing blade that is used to mix the ceramic mold formulation. The drive coupling and sealing arrangement at the base of the mixing vessel is one feature of the present disclosure. The drive shaft is sealed in the coupling to prevent leakage of the ceramic slurry out of the base of the vessel. The Cowles blade 1440 was attached to the shaft that operates through the base of the vessel. The Cowles blade was set at a fixed distance of 20 mm above the base of the mixing vessel.

The mixer was operated at rotational speeds up to and above 3000 rpm and this generates a mixing torus within the mixing vessel with high fluid velocities and significant shear forces within the slurry. The geometry of the mixing vessel and the geometry of the open mixing blade were selected to promote full mixing of every volume element of the ceramic mold formulation, and to minimize the possibility of any recirculation/stagnation zones in the ceramic mold formulation during mixing.

One advantage of this type of mixing machine and method is that the Cowles blade is a commercially available component. However, the Cowles blade 1440 and mixing machine did not produce as good a slurry as that produced with the open knife blade 1430. The Cowles blade did provide some reduction in the size of the cement agglomerates. The slurry viscosity and the amount of air in the slurry mix were not as good as in Example 1 with the open knife blade. Another advantage of this type of mixing machine and method is that there is minimum build up of splatter on the blade. Splatter that can lead to incomplete mixing or unacceptable agglomerates in the mix.

One disadvantage of this type of mixing machine and method is that the Cowles blade 1440 does not function as well as the open knife blade 1430 of Example 1. Another disadvantage of the lower motor type of mixing machine and method is that the heat from the motor beneath the mixing blade can increase the temperature of the mix, which can be undesirable during subsequent curing of the mold; the cement slurry temperature is kept below 30 degrees Celsius. Another disadvantage of lower motor type of mixing machine and method is that the shaft coupling performance and the performance of the seals in the base of the mixing vessel can become reduced from the penetration by the fine cement powder; the powder can cause wear of the shaft and the seals, and as a result the cement slurry can leak from the bottom of the mixing vessel. It is difficult to perform the 2 stage mixing of the initial calcium aluminate cement followed by the bubble with the blade geometry and position in the mixing vessel geometry. Also, the Cowles blade can actually break up the large particles/bubble and reduce the overall size of the bubble. As a result the large particles/bubble are not fully effective in its role in the final mold.

Ceramic mold mixes were made with the following formulation and mixing method: A slurry mixture for making an investment mold consisted of 5416 g of a fine-scale calcium aluminate cement, 2943 g of high-purity alumina bubble of a size range from 0.5-1 mm diameter, 1641 g of deionized water, and 181 g of Remet colloidal silica LP30. A mixing vessel was used with a height of 381 mm, a top opening of 280 mm, a bottom 127 mm, and the width of the mixing blade used was about 112 mm for the open knife blade design.

The mixing method involved first mixing fine-scale (less than 50 micron) calcium aluminate cement with water and colloidal silica to the correct viscosity. In the first stage of mixing, the water and colloidal silica were mixed at a rotational speed of 3000 rpm using the mixing vessel and mixing blade as shown in FIGS. 1-3, and 6-8. The height of the mixing blade above the base mixing vessel was set at 20 mm. After the water and colloidal silica were fully mixed, the fine scale cement was added in a controlled manner to generate a slurry with a solids loading of approximately 70 per cent.

With the lower mixing machine, Cowles blade, and mixing method employed in this example, it was not possible to generate a calcium aluminate cement based ceramic slurry with satisfactory properties for making a mold for casting. The slurry did not possess sufficient uniformity in terms of the cement dispersion, and there were too many air bubbles in the slurry.

### Example #3

### Upper Motor and Shaft with Shrouded In-Line Blade

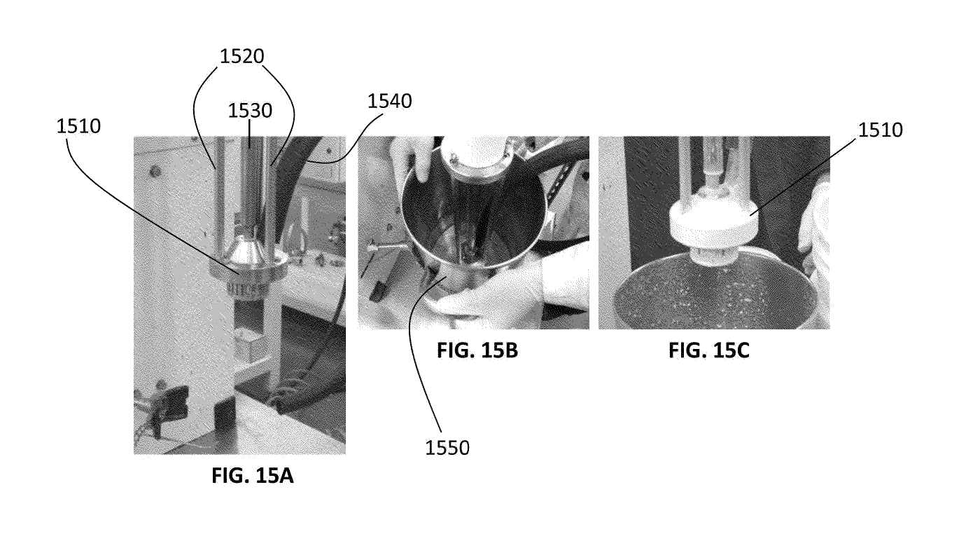

In yet another example, a ceramic mold formulation mixing machine was developed comprising: an upper drive motor, a drive shaft capable of extending into a mixing vessel; a mixing vessel; and a shrouded blade system attached onto the drive shaft wherein the blade system includes blades rotating rapidly within a tight-fitting enclosure (a shroud). A benefit of the shrouded system is that it can generate local regions of high shear that are effective for mixing slurries with fine-scale particles. The blade-shroud assembly is sometimes referred to as the, ‘mixing head’ in the present example. An additional benefit is the feeding of powder directly into the blade-shroud assembly as a result of the vacuum generated in the regions behind the blades in the mixing head. Certain advantages of these features of the upper motor and shaft with shrouded in-line blade were investigated, and the findings are summarized below together with the FIGS. 15A, 15B, 15C, 16A, 16B and 17.

Referring to FIG. 15A-C, the ‘mixing head’ 1510 is positioned in the bottom of the mixing vessel. The mixing head attachment configured with the mixing vessel are shown in FIGS. 15B and 15C. FIG. 15B shows the mixing head in the mixing vessel at the beginning of the mix with the water in the mixing vessel. FIG. 15C shows the mixing head after partial mixing of the cement; the powder feed tube can also be seen in the mixing vessel. The shrouded mixing head 1510 is supported by several support shafts 1520 and the drive shaft 1530 operates at the center of these support shafts. In this example there are three support shafts 1520.

FIG. 15A-15C shows an example where a double mix was attempted in a 3.5 gallon mixing vessel 1550. In this mixer configuration, the rotation generates a vacuum capable of drawing in powder through a tube 1540 connected to the mixer head in the mixing vessel. FIG. 15B shows the same set up as FIG. 15A, however, the drive shaft 1530 can be seen inside of the mixing vessel 1550 from an elevation view point. Powder, e.g. calcium aluminate, was fed through the attached tube 1540 directly into mixing vessel 1550 in which the liquid slurry is mixed. The powder was slowly inserted into mix. In this system, the powder addition was too slow and the vacuum was not strong enough to pull the powder without clogging the system. This mixer configuration was not effective for this application, even at the highest power rating. The mix temperature was about 34° C. and many bubbles formed. The high mix temperature and the bubble formation are undesirable. FIG. 15C shows the head of this mixing set up and under these conditions and set up, the slurry was very thick and mixing could not be completed.

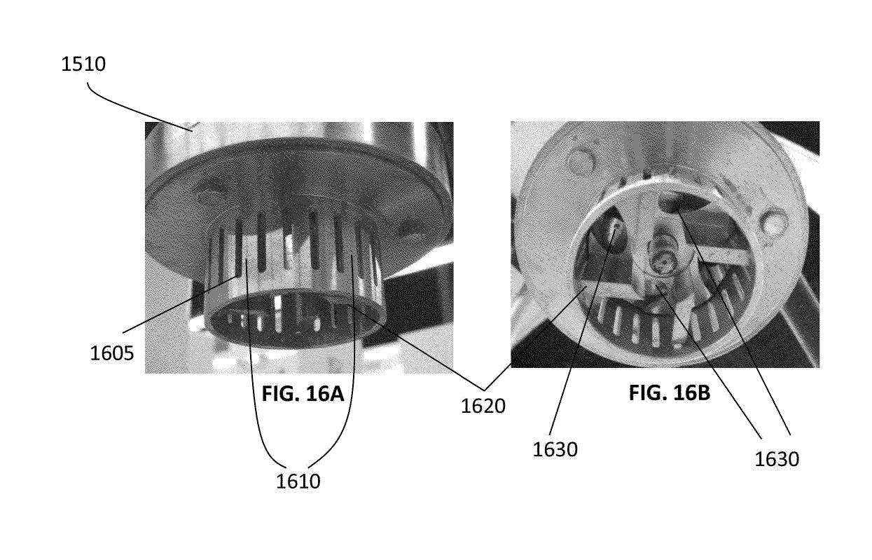

Referring also to FIGS. 16A and 16B, the powder feed tube 1540 connects into the back of the mixing head 1510 and delivers powder directly into the mixing head. FIGS. 16A and 16B shows the side and the base of the mixing head 1510. The mixing blades, the shroud (or stator) 1605, and the rotor/blades 1620 are visible FIG. 16B. As shown in FIG. 16A, the shroud 1605 also contains slots 1610 in order to promote the flow of slurry into and out of the mixing head. The powder can enter the mix through these slots 1610 in the stator 1605. The rotor 1620 pushes and shears cement against the stator 1605. The in-line powder feed ports 1630 allow powder to inter the mix as the rotor spins. When the shrouded mixing blade rotates at speed, it generates a vacuum which is able to draw in powder/cement through this tube and into the mixing head and into the liquid/slurry. In operation of this example, the blades generally provide high local shear but the mixing volume is small and the full mix was not sufficiently uniform.

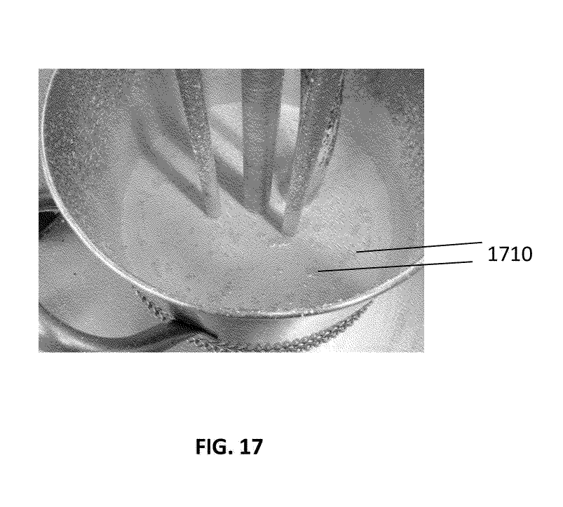

FIG. 17 shows a partially mixed slurry. The slurry was very thick because mixing was not sufficiently effective. For the mix formulation employed, the mixing head was not capable of mixing the slurry to an acceptable viscosity, as can be seen in FIG. 17; there is also too much air in the mix. The ratio of water to colloidal silica to cement that was employed for the mixing trial with this mixer configuration was the same as that used in Example 1.

FIG. 17 shows the set-up of FIG. 15 during operation. As can be seen, too much air was incorporated into the mixture during powder addition and mixing that resulted in air bubbles 1710 in the slurry. The cement proved to be too abrasive for the rotor-stator blade. The four shafts and the vacuum tube needed to be cleaned after each run.

One advantage of the upper motor and shaft with shrouded in-line blade of mixing machine and method is that the mixing motor is above the mix and heat from the motor does not increase the temperature of the mix substantially; this can be undesirable during subsequent curing of the mold. Another advantage of this type of mixing machine and method is that the shrouded mixing head can provide high shear that can be effective at breaking up particulates. Yet another advantage of this type of mixing machine and method is that when the shrouded mixing blade rotates at speed, it generates a vacuum which is able to draw in powder/cement through this tube and into the mixing head and into the liquid/slurry.

One disadvantage of this upper motor and shaft with shrouded in-line blade and method is that the mixing machine did not produce an acceptable reduction in the size of the cement agglomerates, and the slurry viscosity was not acceptable. Another disadvantage of this type of mixing machine and method is that there are too many recirculation and stagnation zones in the mixing blade and shroud system, and these generate a mix of unacceptable uniformity. Another disadvantage of this type of mixing machine and method is that the mixing machine introduces too much air into the slurry mix, as can be seen in FIG. 17. Yet another disadvantage of this type of mixing machine and method is that it is difficult to perform the 2 stage mixing of the initial calcium aluminate cement followed by the bubble with the shrouded blade. The shrouded blade system can attrite the large particles, reduce their size, and make them less effective. Lastly, the blade and shaft are very difficult to clean; any residual material that is not completely removed can be a source of contamination on subsequent cycles, which is yet another disadvantage of this approach.

### Example #4

### Upper Motor and Shaft with Open Cowles Blade

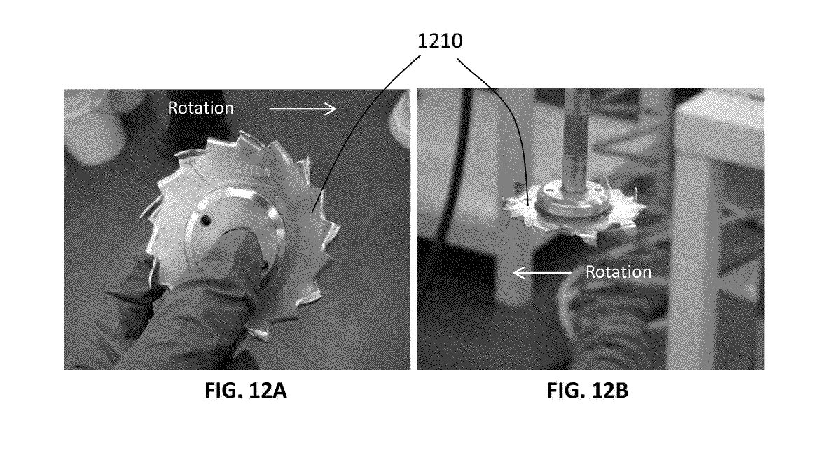

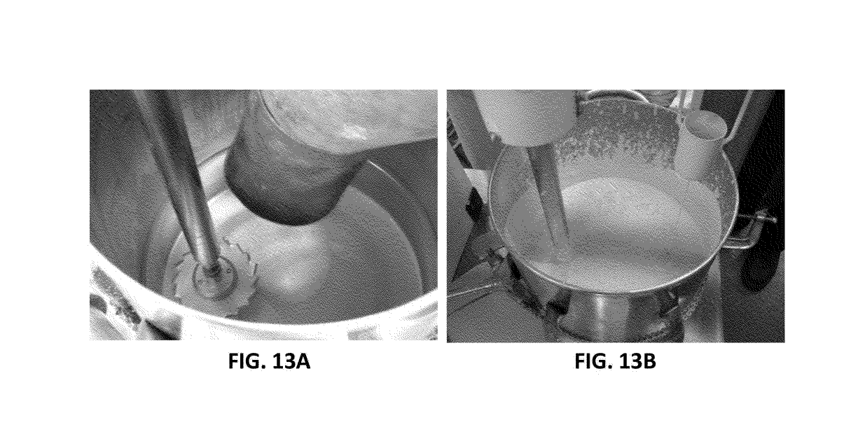

In yet another example, the inventors built a mixing device, comprising: a mixing vessel; a motor above the mixing vessel; a drive shaft attached to the motor, the drive shaft capable of extending into the mixing vessel, and a Cowles blade system attached onto the drive shaft. The blade design is similar to that described in Example 2. The Cowles blade can be seen in FIGS. 12 and 13, in a series of views that show the plane of the mixing blade and the teeth.

The Cowles blade is designed to generate high shear levels to break up powder agglomerates in mixing applications, such as wetting out powders, dispersing fine solids and creating emulsions. FIG. 12A shows a Cowles blade and noted the rotation in relation to the blade. FIG. 12B shows the Cowles blade 1210 attached to a drive shaft and the corresponding rotation. In one example, the Cowles blade operates in an open blade setup with no vacuum feed capability. In such a system, up to 7000 rpm may be achieved; however, the Cowles blade is much more expensive than the presently described open knife blade. For example, the Cowles blade may be approximately 10× more expensive than presently disclosed blade system comprising the open knife blades.

The Cowles blade coupled to the mixing shaft are inserted in the mixing vessel in FIG. 13A. FIG. 13B shows the Cowles blade mixing a mixture of calcium aluminate and water. The shaft in this example is shown offset from the symmetry axis of the mixing vessel.

The Cowles blade was operated off the axis of symmetry of the mixing vessel in order to allow more open axis to the vessel for the addition of ceramic powder/aggregate. It has been found that the off axis position is less desirable in terms of mixing uniformity. However, mixes were also performed in a similar vessel with the blade on the axis of symmetry of the mixing vessel; the mix quality was still not acceptable.

For the mix formulation employed, the Cowles mixing head was not capable of mixing the slurry to an acceptable viscosity; there was also a lot of air in the mix. The ratio of water to colloidal silica to cement that was employed for the mixing trial with this mixer configuration was the same as that used in example 1.

One advantage of the upper motor and shaft with open Cowles blade and method is that heat from the motor above the mixing blade does not increase the temperature of the mix, which can be undesirable during subsequent curing of the molds. Another advantage of this type of mixing machine and method is that the blades can be easily acquired from vendors. Yet another advantage of this type of mixing machine and method is that there is minimum build up of splatter on the mixing blade. Splatter that can lead to incomplete mixing or unacceptable agglomerates in the mix.

One disadvantage of this the upper motor and shaft with open Cowles blade and method is that the Cowles blade does not function as well as the open knife blade of Example 1. Another disadvantage of this type of mixing machine and method is that it is difficult to perform the 2 stage mixing of the initial calcium aluminate cement followed by the bubble with the Cowles blade geometry. The Cowles blade can actually break up the large particles/bubble and reduce the overall size of the bubble. As a result the large particles/bubble are not fully effective in its role in the final mold.

In one embodiment, the Cowles blade is introduced from the bottom of the vessel; that is, the mixing vessel has an entry hole in the bottom of the vessel through which the drive shaft enters the vessel, and at the end of the drive shaft is the Cowles blade. FIG. 14 shows a mixing vessel that sits on top of a motor with a shaft coming up through bottom of vessel. The shaft is operably connected to the motor, such that when the motor is turned on the shaft rotates. The speed of rotation of the shaft if adjustable, so as to achieve the desired speed rpm. In this system, the shaft/bearing system is exposed directly to cement and wears down quickly. Several single mixes were attempted in a tapered vessel; the blade/motor spins at 3000 rpm; the motor heats up quickly and this system is not suitable for many consecutive runs; mixes reach 30-34° C. (this is hot; below 26° C. is used in one example).

### Example #5

### Upper Motor and Shaft with Open Knife Blade

In yet another example, the inventors built a mixing device, comprising: a mixing vessel; a motor above the mixing vessel; a drive shaft attached to said motor, wherein the drive shaft is capable of extending into said mixing vessel, and a blade system attached onto said drive shaft wherein the blade system includes at least two coincidental knife-edged blades such that at least one of the knife-edged blades is facing upward (see FIGS. 7-10). This blade design is referred to as an open knife blade design. The blade design is similar to that described in Example 1. In one embodiment, the blade system includes a third knife-edged blade perpendicular to said two coincidental knife-edged blades. In another embodiment, the drive shaft is substantially inside of the mixing vessel. In one embodiment, the blade system is coated.

The ability to adjust the height of the blade to accommodate mixes of a range of viscosities and flow characteristics within the mixing vessel is one element of this specific machine design and operation. For example, in one embodiment for mixing the calcium aluminate cement into a ceramic slurry, the blade system is lowered from the top of the mixing vessel to about 10 mm from the bottom of the mixing vessel. The cement is mixed into the fluid to make the slurry using a rotational speed of the blades from about 1000 rpm to about 4000 rpm. Using this motor-mixing vessel-mixing blade configuration, the calcium aluminate cement is mixed into a ceramic slurry suitable for making a ceramic mold for casting titanium alloys and titanium aluminide based alloys. This motor-mixing vessel-mixing blade configuration can also be used for mixing the large-scale ceramic powder into the initial calcium aluminate cement containing ceramic slurry. For example, in one embodiment after mixing the calcium aluminate cement into a ceramic slurry, hollow alumina particles (e.g. alumina bubble) were mixed into the slurry to make a ceramic mold mix of acceptable viscosity, rheology, and uniformity for making a ceramic mold.

In another embodiment, the blade system is raised to a height from about 30 mm to about 200 mm from the bottom of the mixing vessel in order to mix large-scale ceramic particulate into the initial slurry. For example, before the second mixture of large scale hollow particles are mixed into the initial slurry, the blade system is lifted to about 110 mm from the bottom of the mixing vessel. The rotation speed of the blades is reduced from the speed of approximately 3000 rpm for the initial ceramic cement slurry to about 500 rpm to about 1500 rpm for mixing the final slurry with the large-scale ceramic particulate.

The machine and mixing method are capable of producing a mix of the desired uniformity; the machine can be configured to minimize any stagnation zones or recirculation zones. The open knife blade in this machine configuration is capable of generating a vortex that is capable of adding fine-scale calcium aluminate cement to the initial fluid to make a ceramic slurry of acceptable viscosity and uniformity. The calcium aluminate cement agglomerates can be broken up and dispersed in the slurry very effectively to generate an acceptable viscosity. The mixing vortex can be set up to remain stable through duration of powder addition. This condition facilitates the generation of a slurry with uniform properties.

The open knife blade in this machine configuration is also capable of generating a vortex that is capable of mixing large-scale ceramic particulate to the calcium aluminate cement-containing ceramic slurry to produce a ceramic mold mix of acceptable viscosity and uniformity, and without adversely breaking up any of the large-scale ceramic particulate.

This example employs a mixing vessel, a motor-controlled drive shaft, wherein said drive shaft is capable of extending into said mixing vessel; and a blade system attached onto said drive shaft wherein the blade system includes at least two coincidental knife-edged blades such that at least one of the knife-edged blades is facing upward. The angle of the drive shaft with respect to the mixing vessel is about plus or minus 5 degrees. The drive shaft is typically positioned on the axis of symmetry of the mixing vessel, although it is possible for the drive shaft to be positioned at some distance off the axis of symmetry of the mixing vessel.

One advantage of this type of mixing machine and method is that the calcium aluminate cement and the larger-scale ceramic powder can be readily fed into the mixing vortex with a guide tube or funnel system using a gravity feed system or other feed system. Another advantage of this type of mixing machine and method is that the open knife blade in this machine configuration is capable of generating a vortex that is capable of adding calcium aluminate cement to the fluid to make a ceramic slurry of acceptable viscosity and uniformity. Adding the calcium aluminate cement agglomerates can be broken up and dispersed in the slurry very effectively to generate an acceptable viscosity. In one example, the vortex remained stable through duration of powder addition. Another advantage of this type of mixing machine and method is that the open knife blade in this machine configuration is capable of generating a vortex for the large-scale ceramic particulate to mix the calcium aluminate cement-containing ceramic slurry to produce a ceramic mold mix of acceptable viscosity and uniformity, and without adversely breaking up any of the large-scale ceramic particulate. Yet another advantage of this type of mixing machine and method is that the machine and mixing method are capable of producing a mix of the desired uniformity, wherein the machine can be configured to minimize stagnation zones or recirculation zones. Another advantage of this type of mixing machine and method is that the machine and mixing method are capable of producing a mix with little to no air bubbles in the mix at the end of the mixing cycle.

During operation, in one example, the mixing motor is removed from the location where the slurry is mixed so heat from the motor above the mixing blade has minimum effect on the temperature of the mix. As a result, heat from the motor does not increase the temperature of the mix, which can be undesirable during subsequent curing of the mold. The mixing blade and the mixing vessel can be easily cleaned, which is easier than the lower motor mounted blade machine.

One disadvantage of this type of mixing machine and method is that the shaft can obstruct the delivery of powder to the mixing vessel. Therefore, the position, angle, and the length of the shaft can be selected to allow sufficient access of the powder delivery mechanism. In addition, the mixing blade shaft should be kept clean so that splatter/debris on the shaft of one mix does not get entrained in subsequent mixes.

Molds were made with the following formulation and method for example 5: A slurry mixture for making an investment mold consisted of 5416 g of a fine-scale calcium aluminate cement, 2943 g of high-purity alumina bubble of a size range from 0.5-1 mm diameter, 1641 g of deionized water, and 181 g of Remet colloidal silica LP30. A mixing vessel was used with a height of 381 mm, a top opening of 280 mm, a bottom 127 mm, and the width of the mixing blade used on the bottom of the shaft of the top mounted mixing motor was about 112 mm.

The mixing method involved first mixing fine-scale (less than 50 micron) calcium aluminate cement to the correct viscosity, and second adding larger-scale (greater than 50 micron) ceramic aggregate of high-purity alumina bubble to the initial calcium aluminate cement mix. In the first stage of mixing, the water and colloidal silica were mixed at a rotational speed of 3000 rpm using the mixing vessel and mixing blade that are shown in FIGS. 2 and 8. The height of the mixer blade above the base mixing vessel was set at 10 mm. After the water and colloidal silica were fully mixed, the fine scale calcium aluminate cement was added in a controlled manner to generate a slurry with a solids loading of approximately 70 per cent.

The slurry was mixed for approximately 6 minutes, at which point it possessed a viscosity of about 100 centipoise. At this point, the mix blade rotational speed was reduced to 1000 rpm and the alumina bubble was added to the slurry in a controlled manner. The height of the mixer blade above the base mixing vessel was set at 11 cm. After 2943 g of high-purity alumina bubble was added to the slurry, the complete ceramic mix was mixed at 1000 rpm for 1 minute to ensure full mixing of the calcium aluminate-containing slurry and the alumina bubble.

After mixing, the investment mold mix was poured in a controlled manner into a vessel that contained the fugitive wax pattern, such as a pattern for a turbine blade. The solids loading of the initial cement slurry mixture with all components without the large-scale alumina particles was approximately 70 per cent. The solids loading of the final mold mix was approximately 82 per cent. The mold was then cured and fired at high temperature. The produced mold was used for casting titanium aluminide-containing articles such as turbine blades.

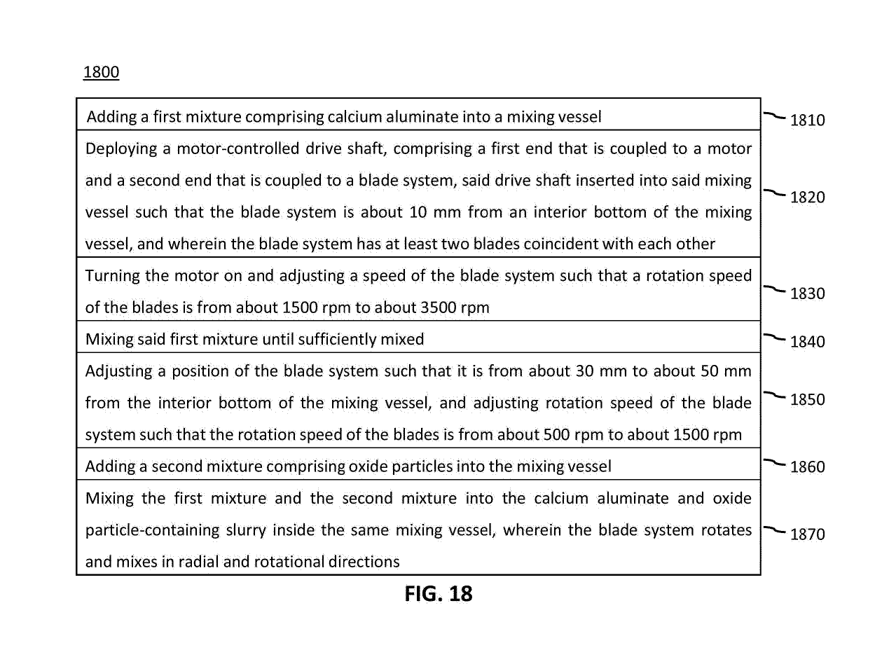

As shown in FIG. 18, in one example, the present disclosure is a method for mixing a calcium aluminate and oxide particle-containing slurry (1800). The method comprises adding a first mixture comprising calcium aluminate into a mixing vessel (1810) and deploying a motor-controlled drive shaft, comprising a first end that is coupled to a motor and a second end that is coupled to a blade system. The drive shaft is inserted into said mixing vessel such that the blade system is about 10 mm from an interior bottom of the mixing vessel, and such that the blade system has at least two blades coincident with each other (1820). The method further comprises turning the motor on and adjusting a speed of the blade system such that the blades rotate at speeds from about 1500 rpm to about 3500 rpm (1830). The first mixture is mixed (1840); and the position of the blade system is adjusted such that it is from about 30 mm to about 50 mm from the interior bottom of the mixing vessel. The and rotation speed of the blade system is also adjusted such that the rotation speed of the blades is from about 500 rpm to about 1500 rpm (1850). A second mixture comprising oxide particles is then added into the mixing vessel (1860); and the first and second mixtures are mixed inside the same mixing vessel (1870). The blade system rotates and mixes in radial and rotational directions.

| | | Option 2 - | | | |
|---|---|---|---|---|---|
| | Option 1 - | Bottom | | Option 4 - | Option 5 - |
| | Bottom | Motor & | Option 3 - | Top Motor | Top |
| | Motor & | Shaft | Top Motor & | & Shaft | Motor & |
| | Shaft | Open | Shaft | Open | Shaft |
| | Open | Disperser | Shrouded | Disperser | Open |
| | Knife | Blade | Inline | Blade | Knife |
| Criteria | Blade | (Cowles) | Attachment | (Cowles) | Blade |
| Viscosity and viscosity | 4 | 3 | 1 | 3 | 4 |
| profile | | | | | |
| Mix homogeneity | 5 | 2 | 1 | 2 | 5 |
| Mixer clean up | 2 | 2 | 1 | 4 | 4 |
| Foaming of the mix | 3 | 3 | 1 | 5 | 5 |
| Powder introduction | 5 | 5 | 1 | 4 | 4 |
| Mixing speed (RPM) | 3 | 3 | 1 | 5 | 5 |
| and variability | | | | | |
| Total | 22 | 18 | 6 | 23 | 27 |

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A mixing device for mixing a calcium aluminate-containing slurry, comprising:
a mixing vessel having an interior bottom surface and interior walls, wherein the mixing vessel is configured to contain the slurry;
a motor-controlled drive shaft, wherein a first end of said drive shaft is coupled to a motor and a second end of the drive shaft is configured to extend into said mixing vessel; and
a blade system attached onto said second end of the drive shaft, wherein the blade system includes at least two coincidental knife-edged blades such that at least one of the knife-edged blades is facing upward, wherein the knife-edged blades can be move up or down in the mixing vessel, and wherein the rotational speed of the knife-edged blades can be adjusted to be between 500 rpm to 5000 rpm.

2. The device according to claim 1, wherein the blade system includes a third knife-edged blade perpendicular to said two coincidental knife-edged blades.

3. The device according to claim 1, wherein the second end of the drive shaft is coated and substantially inside of the mixing vessel.

4. The device according to claim 1, wherein the knife-edged blades are made of stainless steel and/or are coated with chromium or chromium-containing alloy.

5. A method for mixing a calcium aluminate and oxide particle-containing slurry, comprising:
adding a first mixture comprising calcium aluminate into a mixing vessel;
deploying a motor-controlled drive shaft, comprising a first end that is coupled to a motor and a second end that is coupled to a blade system, said drive shaft inserted into said mixing vessel such that the blade system is about 10 mm from an interior bottom of the mixing vessel, and wherein the blade system has at least two blades coincident with each other;
turning the motor on and adjusting a speed of the blade system such that a rotation speed of the blades is from about 1500 rpm to about 3500 rpm;
mixing said first mixture until sufficiently mixed;
adjusting a position of the blade system such that it is from about 30 mm to about 50 mm from the interior bottom of the mixing vessel, and adjusting rotation speed of the blade system such that the rotation speed of the blades is from about 500 rpm to about 1500 rpm;
adding a second mixture comprising oxide particles into the mixing vessel; and
mixing the first mixture and the second mixture inside the same mixing vessel, wherein the blade system rotates and mixes in radial and rotational directions.

6. The method of claim 5, wherein said oxide particles comprise hollow alumina spheres.

7. The method of claim 5, wherein the first mixture comprises particles of calcium aluminate that are less than about 50 microns in outside dimension and the second mixture comprises oxide particles that are substantially hollow particles of about 100 microns to 1000 microns in outside dimension.

8. The method of claim 5, wherein the blade system comprises at least two knife-edged blades positioned coincident to each other in the radial and rotational directions, wherein the knife-edged blades are different in size, at least one of the knife-edged blades is facing upward.

9. The method of claim 5, wherein the mixing vessel further comprises a powder feed funnel for adding the first and second mixture into the mixing vessel, wherein said funnel has one side that is flat such that when the funnel is in contact with the mixing vessel, said flat side stays flush with the mixing vessel.

10. The method of claim 5, further comprising generating a toroid during said mixing.

11. A blade system, comprising:
at least two knife-edged blades positioned coincident to each other in the radial and rotational directions, wherein the knife-edged blades are different in size, at least one of the knife-edged blades is facing upward, and further wherein the blade system is attached to the rotatable shaft, and wherein the knife-edged blades are used for mixing a calcium aluminate-containing slurry.

12. The blade system of claim 11, further comprising a third knife-edged blade that is perpendicular to said two coincidental knife-edged blades.

13. The blade system of claim 11, wherein the knife-edged blades operate in at least two of radial, rotational, and axial directions.

14. The blade system of claim 11, wherein the knife-edged blades are coated.

15. The blade system of claim 11, wherein the knife-edged blades are made of stainless steel and/or are coated with chromium or chromium-containing alloy.

16. The blade system of claim 11, wherein the knife-edged blades are star-shaped.

17. The blade system of claim 11, wherein each blade of the blade system has a top surface and a bottom surface and two vanes.
